(19) United States
(12) Patent Application Publication
(10) Pub. No.: US 2018/0174250 A1
(43) Pub. Date: Jun. 21, 2018

(54) CONSTRUCTION PROJECT MANAGEMENT SYSTEMS AND METHODS

(71) Applicant: Headstream Technologies, LLC, Charlotte, MI (US)

(72) Inventor: Anthony Faulkner, Olivet, MI (US)

(73) Assignee: Headstream Technologies, LLC, Charlotte, MI (US)

(21) Appl. No.: 15/845,956

(22) Filed: Dec. 18, 2017

Related U.S. Application Data
(60) Provisional application No. 62/435,682, filed on Dec. 16, 2016.

(51) Int. Cl. G06Q 50/08; G06Q 10/06; G06F 3/0484; G06F 3/0482

(52) U.S. Cl. CPC G06Q 50/08; G06Q 10/063118; G06Q 10/0633; G06F 3/0482; G06F 3/04842

(57) ABSTRACT

A system and a method are provided for construction project management graphical user interfaces (GUIs). An operation performed by the system and the method include generating a project profile for a construction project, determining project details of the project, determining a regulatory process to be performed during the project based on the project details and regulatory rules, determining worker's certificates or licenses corresponding to the regulatory process and the project details, determining candidate workers for the construction project from registered workers, and causing a first GUI for selection of one or more candidate workers to be generated. The first GUI includes indicators of statuses of the worker's certificates or licenses corresponding to the regulatory process with respect to each of the one or more candidate workers.

### CROSS-REFERENCE TO RELATED APPLICATIONS

This application claims priority to U.S. Patent Application Ser. No. 62/435,682 filed Dec. 16, 2016 and entitled “Construction Project Management Systems and Methods,” which is incorporated by reference herein.

### FIELD OF THE INVENTION

This disclosure relates to approaches for construction project management systems and methods.

### BACKGROUND

Construction projects, especially renovations of old structures, may require special regulatory procedures in contrast to construction of new buildings. For example, houses built before a certain year (e.g., 1978) may require special regulatory procedures to remove hazardous construction materials used in houses, such as asbestos and lead paintings and plumbing materials. Some regulatory rules further require construction work on regulatory procedures to be performed by certified or licensed workers. If the regulatory procedures are not properly performed or if the regulatory procedures are performed but not performed properly by certified or licensed workers, fines or penalty may be imposed on construction companies (e.g., a general constructor, contractors, and/or sub-contractors), construction workers, inspectors, and/or property owners, depending on regulatory rules. For that reason, when a new construction project starts, it is important to comply with the regulatory rules. In addition, construction work may suffer delay because of various possible reasons, severe weather conditions (e.g., rain, wind, heat, or the like), failure to pass inspections, unknown property conditions, or the like. It is important to manage construction progress and assign a proper amount of personnel to complete construction projects in time.

### SUMMARY

Various embodiments of the present disclosure can include systems, methods, and non-transitory computer readable media. In some embodiments, a system includes one or more processors, and a memory storing instructions that, when executed by the one or more processors, cause the system to perform operations. In some embodiments, a method includes the operations. In some embodiments, a non-transitory computer readable medium includes instructions to perform the operations. The operations include generating a project profile for a construction project at a property, determining project details of the construction project, determining a regulatory process to be performed with respect to the property during the construction project based on the project details and regulatory rules, determining worker's certificates or licenses corresponding to the regulatory process and the project details of the construction project, determining candidate workers for the construction project from registered workers for whom worker profiles are registered, worker profiles for the candidate workers including the worker's certificates or licenses corresponding to the regulatory process, and causing a first GUI for selection of one or more candidate workers to be generated. In some embodiments, the first GUI includes indicators of statuses of the worker's certificates or licenses corresponding to the regulatory process with respect to each of the one or more candidate workers.

The operations may further include determining a workflow of the construction project based on the project details and the regulatory process to be performed, and causing a second GUI indicating the determined workflow of the construction project to be generated on terminals associated with one or more of the candidate workers selected through the GUI.

In some embodiments, the operations further include validating a completion of a step of the workflow based on an on-site input for the step. The operations may further include disabling the validation of the completion of the step of the workflow when the on-site input is associated with a worker whose worker profile indicates lack of a certificate or a license required to perform the step. In some embodiments, the operations further include disabling validation a completion of a second step of the workflow that follows the step of the workflow until the validation of the completion of the step.

In some embodiments, the operations further include enabling approval of completion of the construction project based on a signature input, upon validation of a last step of the workflow. In various embodiments, the operations may further include, upon completion of steps of the workflow, closing the project profile and updating worker profiles of the one or more selected candidate workers such that the worker profiles include project history of the construction project. It will be appreciated that the operations may further include, upon completion of steps of the workflow, causing a third GUI for rating the construction project to be generated.

The operations may further include determining certifications or licenses associated with one or more construction project assignments, determining whether or not a worker has the determined certifications or licenses by referring to a worker profile of the worker, and upon determining that the worker possesses at least one of the determined certifications or licenses, determining an expiration date of the at least one certification or license, and causing a fourth GUI including a notification of the expiration date of the at least one certification or license to be generated on a terminal associated with the worker.

In some embodiments, the operations further include determining certifications or licenses for one or more construction project assignments, determining whether or not a worker has the determined certifications or licenses by referring to a worker profile of the worker, and upon determining that the worker possesses none of the determined certifications or licenses, causing a fifth GUI including a notification of missing certifications or licenses to be generated on a terminal associated with the worker.

The operations further include causing a fifth GUI for starting an online training session associated with one of the determined certifications or licenses to be generated on a terminal associated with a worker, and causing a sixth GUI of the online training session to be generated upon start of the online training session. In some embodiments, the operations further include updating a status of the one of the determined certifications or licenses included in the worker profile as being possessed, upon completion of the online training session.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention(s).

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention(s) are utilized, and the accompanying drawings of which:

FIG. 1 is a network diagram illustrating an example of a construction project management system according to some embodiments.

FIG. 2 is an architecture diagram illustrating a detailed structure of a regulation-compliant construction management server included in a construction project management system according to some embodiments.

FIG. 3 is an architecture diagram illustrating a detailed structure of a worker service engine according to some embodiments.

FIG. 4 is a flowchart of an example of a method for managing a construction worker profile according to some embodiments.

FIG. 5 is a diagram illustrating an example of a graphical user interface (GUI) for providing project management service to workers and managing construction worker profiles according to some embodiments.

FIG. 6 is an architecture diagram illustrating a detailed structure of an administrator service engine according to some embodiments.

FIG. 7 is a flowchart of an example of a method for managing a construction project profile according to some embodiments.

FIG. 8 is a flowchart of another example of a method for managing a construction project profile according to some embodiments.

FIG. 9 is a diagram illustrating an example of a GUI for providing project and worker management service to administrators according to some embodiments.

FIG. 10 is a diagram illustrating another example of a GUI for providing project and worker management service to administrators according to some embodiments.

FIG. 11 is a diagram illustrating another example of a GUI for providing project and worker management service to administrators according to some embodiments.

FIG. 12 is an architecture diagram illustrating a detailed structure of a property owner service engine according to some embodiments.

FIG. 13 is a flowchart of an example of a method for managing a construction property profile according to some embodiments.

FIG. 14 is a diagram illustrating an example of a GUI for providing property management service to property owners according to some embodiments.

FIG. 15 is a diagram illustrating another example of a GUI for providing property management service to property owners according to some embodiments.

FIG. 16 illustrates a block diagram of an example computer system in which any of the embodiments described herein may be implemented.

### DETAILED DESCRIPTION

Various embodiments of the present disclosure may include systems, methods, and non-transitory computer readable media configured to perform functions and computer-based generation of interactive graphical user interfaces (GUI) for managing regulatory procedures required or recommended on construction projects. In some embodiments, a system includes one or more processors, and a memory storing instructions that, when executed by the one or more processors, cause the system to perform operations. A method may include the operations. In some embodiments, a non-transitory computer readable medium includes instructions to perform the operations. The operations may include generating a construction project profile for a construction project at a property, determining project details of the construction project, determining a regulatory process to be performed with respect to the property during the construction project based on the project details and regulatory rules, determining worker's certificates or licenses corresponding to the regulatory process and the project details of the construction project, determining candidate workers for the construction project from registered workers for whom worker profiles are registered, worker profiles for the candidate workers including the worker's certificates or licenses corresponding to the regulatory process, and causing a first GUI for selection of one or more candidate workers to be generated. The first GUI may include indicators of statuses of the worker's certificates or licenses corresponding to the regulatory process with respect to each of the one or more candidate workers.

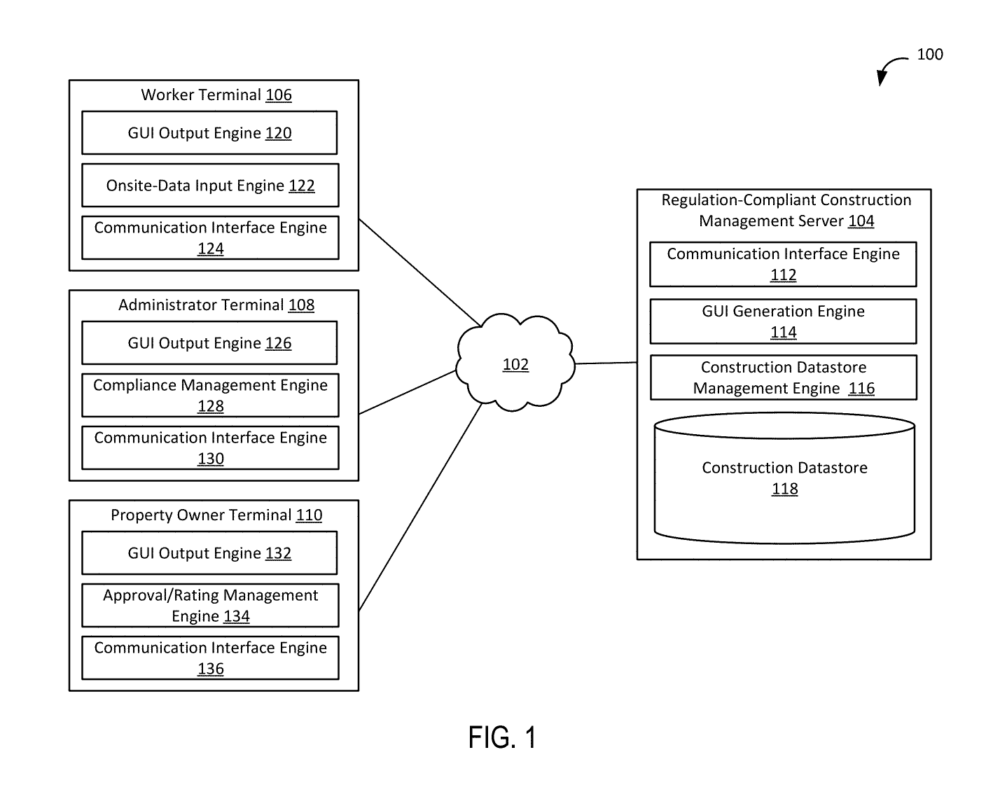

FIG. 1 is a network diagram 100 illustrating an example of a construction project management system according to some embodiments. The construction project management system includes a regulation-compliant construction management server 104, worker terminal(s) 106, administrator terminal(s) 108, and property owner terminal(s) 110, which are communicatively coupled to each other via a network 102. The network 102 may be any applicable network that enables communication between or among systems, machines, databases, and devices (e.g., between a worker terminal 106 and the regulation-compliant construction management server 104). For example, the network 102 may be a wired network, a wireless network (e.g., a mobile or cellular network), or any suitable combination thereof. The network 102 may include one or more portions that constitute a private network, a public network (e.g., the Internet), or any suitable combination thereof. Accordingly, the network 112 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a WiFi network or WiMAX network), or any suitable combination thereof. Any one or more portions of the network 112 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

In some embodiments, database described herein may be, include, or interface to, the Microsoft Azure Cloud Computing Platform. Other databases, such as Informix™, DB2 (Database 2) or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The databases may comprise one or more such databases that reside in one or more physical devices and in one or more physical locations. The database may store a plurality of types of data and/or files and associated data or file descriptions, administrative information, or any other data.

The regulation-compliant construction management server 104 may represent one or more computer systems configured to maintain datasets for managing construction projects and workers and provide data for graphical user interface (GUI) for construction projects to the worker terminal(s) 106, the administrator terminal(s) 108, and the property owner terminal(s) 110. In some implementations, the one or more computer systems may be provided at a single location or provided in a distributed manner. In some examples, the one or more of the computer system are configured as a server (e.g., having one or more server blades, processors, or the like), a handheld gaming device, a personal computer (e.g., a desktop computer, a laptop computer, or the like), a smartphone, a tablet computing device, and/or other device that can be programmed to receive construction-related datasets, analyze construction-related datasets, and generate datasets for GUIs for managing construction projects.

The construction-related datasets may include datasets related to regulatory procedures and/or certificates/licenses regulated under laws and/or regulatory rules. It will be appreciated that a dataset can contain any applicable contents and be in any applicable format. For example, the dataset may be a text file in a format such as HTML, PDF, or Microsoft Office, etc., an image file in a format such as JPEG, GIF, TIFF, etc., an audio file in a format such as MP3, WAV, WMA, etc., a video file in a format such as AVI, MPEG, MP4, etc., a compressed file in a format such as ZIP, an object file in a format such as exe, and so on. A dataset may be, for example, generated by an external application running on a computer system(s) inside or outside of the construction project management system. In some embodiments, laws and/or regulatory rules may include EPA regulations, OSHA regulations, and municipal regulations, etc. In one example, an EPA regulation provides specific work practice standards for lead-containing construction materials, an OSHA regulation provides a specific worksite safety for construction workers, and a municipal regulation provides a specific road use standard or a construction permit standard for construction projects.

The worker terminal(s) 106 may represent one or more computer systems carried by construction workers and configured to communicate with the regulation-compliant construction management server 104 to transmit and receive construction-related datasets. In some embodiments, a worker terminal 106 is configured to capture images of construction sites where regulatory procedures are being carried out, capture or download images of certificates/licenses, and/or send the captured or downloaded images to the regulation-compliant construction management server 104 for regulation-compliance construction management. The worker terminal 106 may be configured to receive notifications regarding regulatory procedures and/or certificates/licenses from the regulation-compliant construction management server 104. The worker terminal(s) 106 may also be configured to communicate with the administrator terminal(s) 108 and/or property owner terminal(s) 110 to transmit and receive construction-related datasets.

The administrator terminal(s) 108 may represent one or more computer systems carried by construction administrators and configured to communicate with the regulation-compliant construction management server 104 to transmit and receive construction-related datasets. In some embodiments, an administrator terminal 108 is configured to receive or generate a new construction project profile for a new construction project and send the new construction project profile to the regulation-compliant construction management server 104 for regulation-compliance construction management. The administrator terminal 108 may be configured to receive one or more construction worker profiles for construction workers and send an instruction to assign construction workers for a new construction project to the regulation-compliant construction management server 104. The administrator terminal(s) 108 may also be configured to communicate with the worker terminal(s) 106 and/or property owner terminal(s) 110 to transmit and receive construction-related datasets. An administrator may include a human or artificial agent having an administrative authority under construction entities, such as a general constructors, contractors, and sub-contractors.

The property owner terminal(s) 110 may represent one or more computer systems carried by or owned by property owners and configured to communicate with the regulation-compliant construction management server 104 to transmit and receive construction-related datasets. In some embodiments, a property owner terminal 110 is configured to receive a construction property profile for a property owned by a property owner carrying the property owner terminal 110. In an example, the construction property profile may include progress status of a construction project, an estimated completion date of the construction project, and so on. The property owner terminal 110 may be configured to transmit an owner's approval of a construction project that has been performed on a property and/or a rating of the construction project. A property owner may include an owner, a resident, a leasing party, and/or so on, of a property.

The construction project management system may include other computer systems connected to the network 102, such as computer systems of regulatory entities such as government entities, computer systems of auditing entities, computer systems of insurance companies, computer systems of public property searching entities (e.g., Zillow, Trulia, Redfin, or the like)

The regulation-compliant construction management server 104 includes a communication interface engine 112, a GUI generation engine 114, a construction datastore management engine 116, and construction datastore 118. In some embodiments, the communication interface engine 112 may represent a functional module configured to perform wireless and/or wired communication with a computing device. For example, when data is transmitted from the regulation-compliant construction management server 104, the communication interface engine 112 may be configured to generate a transmission signal (e.g., packets signals) corresponding to the data to be transmitted and transmit the generated transmission signal. In another example, when data from an external device is received by the regulation-compliant construction management server 104, the communication interface engine 112 is configured to receive the data, format the received data into a suitable format or size for processing protocols of components of the regulation-compliant construction management server 104, and the regulation-compliant construction management server 104 operates based on the data obtained by the communication interface engine 112. In some embodiments, the communication interface engine 112 is configured to set up a virtual private network (VPN) specifically prepared for utilizing the regulation-compliant construction management server 104, such that the communication interface engine 112 communicates through the VPN.

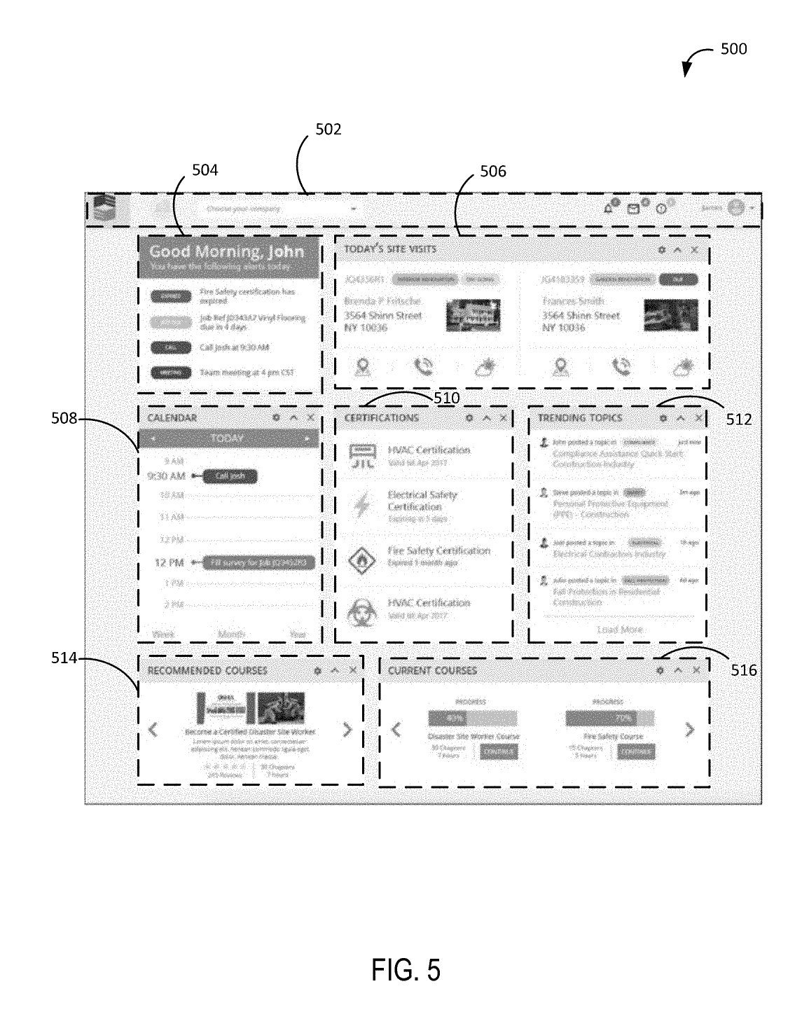

In some embodiments, the GUI generation engine 114 may represent a functional module configured to generate datasets for presenting GUIs on the worker terminal (s) 106, the administrator terminal(s) 108, and the property owner terminal(s) 110. Depending on a specific executed application, the GUIs include applicable graphical presentation. For example, a GUI to be presented to a worker terminal 106 (e.g., a worker portal GUI) may include a work schedule calendar, construction project sites to be visited, status of certification/licenses required or recommended for construction projects, and/or educational course offers to renew or acquire certification/licenses. In another example, a GUI to be presented to an administrator terminal 108 (e.g., an administrator portal GUI) may include on-going construction project stats, up-coming construction project stats, contractor comparison and rating stats, construction worker stats, a project geolocation map, and so on. In still another example, a GUI to be presented to an administrator terminal 108 (e.g., a project assignment GUI) may include a list of construction workers to be assigned to a construction project. In yet another example, a GUI to be presented to a property owner terminal 110 (e.g., a property portal GUI) may include property details of a property, construction project details of a construction project performed on the property, alerts associated with the construction project, and so on. In yet another example, a GUI to be presented to a property owner terminal 110 (e.g., an individual work detail GUI) may include a project progress, an on-going step of a construction project, photo images of a construction target, and so on. A variety of GUIs presented according to GUI generation engine 114 will be discussed below with reference to the below-discussed figures (e.g., FIGS. 5, 9, 10, 13, and 14).

The construction datastore management engine 116 may represent a functional module configured to generate or receive construction-related datasets, such as construction project profiles, construction worker profiles, and construction property profiles, and manage the construction-related datasets in the construction datastore 118. In some embodiments, the construction datastore management engine 116 generates a construction project profile based on datasets received from one or more of the worker terminal(s) 106, the administrator terminal(s) 108, and the property owner terminal(s) 110. Datasets received from one or more of the worker terminal(s) 106, the administrator terminal(s) 108, and the property owner terminal(s) 110 may include a type of construction project (e.g., painting, plumbing, carpet flooring, room restructuring, or the like), a construction year of a property, a geographical location of the property, construction materials and/or tools to be used, a budget, a due date, and so on.

In some embodiments, the construction datastore management engine 116 receives a construction project profile from one of the worker terminal(s) 106, the administrator terminal(s) 108, and the property owner terminal(s) 110. The construction project profile may include one or more of project details of a construction project, a regulatory process to be performed with respect to the construction project, and worker's certificates/licenses associated with (e.g., required or recommended for) the construction project. The project details may include similar information as the datasets to generate a construction project profile.

The construction datastore management engine 116 may generate a construction worker profile based on datasets received from one or more of the worker terminal(s) 106, the administrator terminal(s) 108, and the property owner terminal(s) 110. The datasets received from one or more of the worker terminal(s) 106, the administrator terminal(s) 108, and the property owner terminal(s) 110 may include name or identifier of a worker, specialty of the worker (e.g., painter, plumber, welder, crane operator, or the like), geographic location (e.g., service area) of the worker, and status of certifications/licenses related to construction projects and/or specific to the specialty. In some embodiments, the construction datastore management engine 116 receives a construction worker profile from one of the worker terminal(s) 106 and the administrator terminal(s) 108. The construction worker profile may include one or more of worker details of a worker, project details of construction projects assigned to the worker, and so on. The worker details may include similar information as the datasets to generate a construction worker profile.

In some embodiments, the construction datastore management engine 116 generates a construction property profile based on datasets received from one or more of the worker terminal(s) 106, the administrator terminal(s) 108, and the property owner terminal(s) 110. The datasets received from one or more of the worker terminal(s) 106, the administrator terminal(s) 108, and the property owner terminal(s) 110 may include name or identifier of a property owner, a geographical location and area of a property, restrictive law or regulatory rules (e.g., zoning) associated with the property. In some embodiments, the construction datastore management engine 116 receives a construction worker profile from one of the worker terminal(s) 106, the administrator terminal(s) 108, and the property owner terminal(s) 110. A construction property profile may include one or more of property details of a property, project details of construction projects performed on the property, and so on. The property details may include similar information as the datasets to generate a construction property profile.

In some embodiments, the construction datastore 118 may represent a functional module configured to store construction-related datasets, such as the construction project profiles, construction worker profiles, and construction property profiles. The construction-related datasets may include laws or regulatory rules associated with construction projects with respect to one or more specific regulatory regions (e.g., municipal regions), specific regulatory procedures associated with the laws or regulatory rules, and specific certificates/licenses associated with the specific regulatory regions and/or the specific regulatory procedures. In some embodiments, the construction datastore 118 employs an architecture of a database described above.

The construction datastore 118 may include one or more separate (or combined) table for construction worker profiles, table for construction project profiles, and table for construction property profiles. In some embodiments, the table for construction worker profiles includes a plurality of entries each of which corresponds to one construction worker profile; the table for construction project profiles includes a plurality of entries each of which corresponds to one construction project profile; and the table for construction property profiles includes a plurality of entries each of which corresponds to one construction property profile. In some embodiments, an entry of a construction worker profile includes identifiers (e.g., entry ID) of one or more associated construction project profiles and one or more associated construction property profiles. The same may be true for entries of construction project profiles and construction property profiles. When there is an update of information in an entry, associated entries may be also synchronously updated to reflect the update of the information.

In some embodiments, the construction datastore 118 includes a unified table for two or more of construction worker profiles, construction project profiles, and construction property profiles. The table may include a plurality of entries and each of the entries corresponds to a profile (e.g., a construction worker profile, a construction project profile, or a construction property profile). Association among entries and synchronized update may be carried out in the same manner as the above embodiments of separate tables. Advantageously, when a substantial number of datasets (e.g., property address, progress state, or the like) overlap among entries of different profile types, the amount of data managed in the construction datastore 118 can be reduced.

In the example of FIG. 1, a worker terminal 106 includes a GUI output engine 120, an onsite-data input engine 122, and a communication interface engine 124. In some embodiments, the GUI output engine 120 may represent a functional module configured to output a GUI based on datasets for GUI received from the communication interface engine 112 of the regulation-compliant construction management server 104 by the communication interface engine 124. The GUI output by the GUI output engine 120 may include a worker portal GUI, and various applicable GUIs navigated from the worker portal GUI. In some examples, the GUIs output by the GUI output engine 120 may be presented on a display of the worker terminal 106 and/or any applicable external displays.

The onsite-data input engine 122 may represent a functional module configured to capture and/or receive onsite-data inputs at a construction site. In some embodiments, the onsite-data input engine 122 is configured to capture pictures and/or video images of a construction site by using an image capturing module (e.g., camera, microphones). The onsite-data input engine 122 may be configured to measure dimensions of materials at a construction site based on a captured image of the construction site. In some embodiments, the onsite-data input engine 122 is configured to receive user inputs made at a construction site, such as property inspection details. The property inspection details may include property conditions, materials used at a property, attributes of residents (e.g., child under certain ages), property build year, etc.

The communication interface engine 124 may represent a functional module configured to perform wireless and/or wired communication with a computing device. In some embodiments, the communication interface engine 124 is configured in the same or similar manner as the communication interface engine 112 of the regulation-compliant construction management server 104. In various embodiments, the communication interface engine 124 is configured to transmit the onsite-data inputs to the regulation-compliant construction management server 104, such that the regulation-compliant construction management server 104 generates, updates, and/or manages various applicable profiles, such as construction project profiles, construction worker profiles, and construction property profiles.

In the example of FIG. 1, an administrator terminal 108 includes a GUI output engine 126, a compliance management engine 128, and a communication interface engine 130. Similar to the GUI output engine 120 of a worker terminal 106, the GUI output engine 126 may represent a functional module configured to output a GUI based on datasets for GUI received from the communication interface engine 112 of the regulation-compliant construction management server 104 by the communication interface engine 130. In some embodiments, the GUI output by the GUI output engine 120 includes a project portal GUI, and various applicable GUIs navigated from the project portal GUI including a project assignment GUI. GUIs output by the GUI output engine 126, in some examples, are presented on a display of the administrator terminal 108 and/or any applicable external displays.

In some embodiments, the compliance management engine 128 may represent a functional module configured to determine regulatory procedures associated with a construction project. For example, when an administrator generates a construction project profile and/or input details of a construction project, the compliance management engine 128 may determine regulatory procedures to be performed during the construction project based on details of the construction project. In some embodiments, the compliance management engine 128 is also configured to determine certificates/licenses associated with a construction project and/or with regulatory procedures associated with the construction project. For example, when an administrator generates a construction project profile and/or input details of a construction project and/or when the compliance management engine 128 may determine regulatory procedures to be performed, the compliance management engine 128 may determine the associated certificates/licenses.

In some embodiments, the communication interface engine 130 is configured to work in the same or similar manner as the communication interface engine 112 of the regulation-compliant construction management server 104 and/or the communication interface engine 124 of a work terminal 106. The communication interface engine 130 may be configured to transmit the regulatory procedures to be performed and/or the associated certificates/licenses to the regulation-compliant construction management server 104, such that the regulation-compliant construction management server 104 generates, updates, and/or manages various applicable profiles, such as construction project profiles, construction worker profiles, and construction property profiles.

In the example of FIG. 1, a property owner terminal 110 includes a GUI output engine 132, an approval/rating management engine 134, and a communication interface engine 136.

In some embodiments, similarly to the GUI output engine 120 of a worker terminal 106 and/or the GUI output engine 126 of an administrator terminal 108, the GUI output engine 132 may represent a functional module configured to output a GUI based on datasets for GUI received from the communication interface engine 112 of the regulation-compliant construction management server 104 by the communication interface engine 136. The GUI output by the GUI output engine 132 may include a property portal GUI, and various applicable GUIs navigated from the property portal GUI including an individual work detail GUI. In some embodiments, GUIs output by the GUI output engine 132 are presented on a display of the property owner terminal 110 and/or any applicable external displays.

The approval/rating management engine 134 may represent a functional module configured to receive inputs regarding approval of a step of a construction project and/or approval of an entire construction project. For example, when a step of a construction project is completed (e.g., the approval/rating management engine 134 receives such notice from the regulation-compliant construction management server 104), the approval/rating management engine 134 may generate an alert for a property owner to approve the step of the construction project before the next step is started and also generates a GUI for receiving approval (e.g., signature). In another example, when a construction project is completed (e.g., the approval/rating management engine 134 receives such notice from the regulation-compliant construction management server 104), the approval/rating management engine 134 generates an alert for a property owner to approval completion of the construction project and also generates a GUI for receiving approval (e.g., signature). In still another example, when a construction project (or a step thereof) is completed, the approval/rating management engine 134 may cause the GUI output engine 132 to generate a rating GUI for a property owner to make a rating of the construction project, a step thereof, a construction entity, construction workers, and so on.

When a construction project is completed (e.g., the approval/rating management engine 134 receives such notice from the regulation-compliant construction management server 104), the approval/rating management engine 134 may generate an alert for a property owner to approval completion of the construction project and also generates a GUI for receiving approval (e.g., signature). This process may automatically generate, through the GUI, a closure report detailing aspects associated to the job. In one example, the regulation-compliant construction management server 104 may, upon receiving confirmation that the project is completed, assemble and provide associated documentation regarding the project, site process documentation, images, and/or the like. This closure report is mandated in law and may be provided to the property owner immediately (or soon thereafter) upon closure of the job and or certification of completion (signature).

The communication interface engine 136 may represent a functional module configured to perform wireless and/or wired communication with a computing device. In some embodiments, the communication interface engine 136 is configured in the same or similar manner as the communication interface engine 112 of the regulation-compliant construction management server 104, the communication interface engine 124 of a work terminal 106, and/or the communication interface engine 130 of an administrator terminal 108. In some embodiments, the communication interface engine 136 is configured to transmit approval and/or rating datasets to the regulation-compliant construction management server 104, such that the regulation-compliant construction management server 104 generates and/or manages various applicable profiles, such as construction project profiles, construction worker profiles, and construction property profiles.

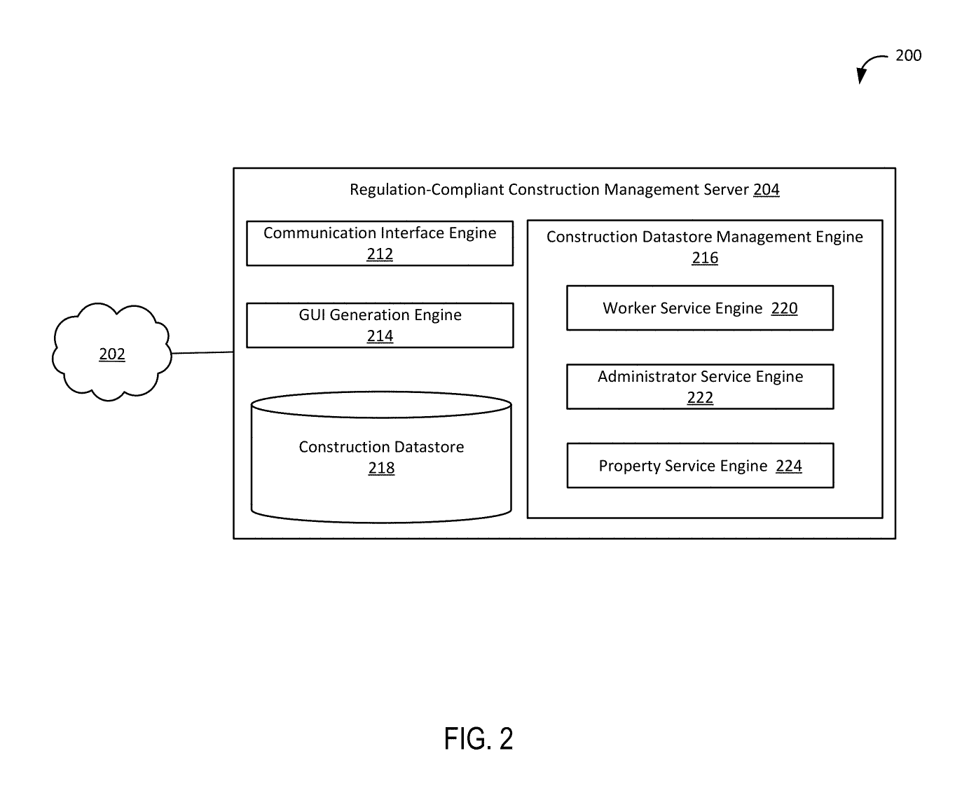

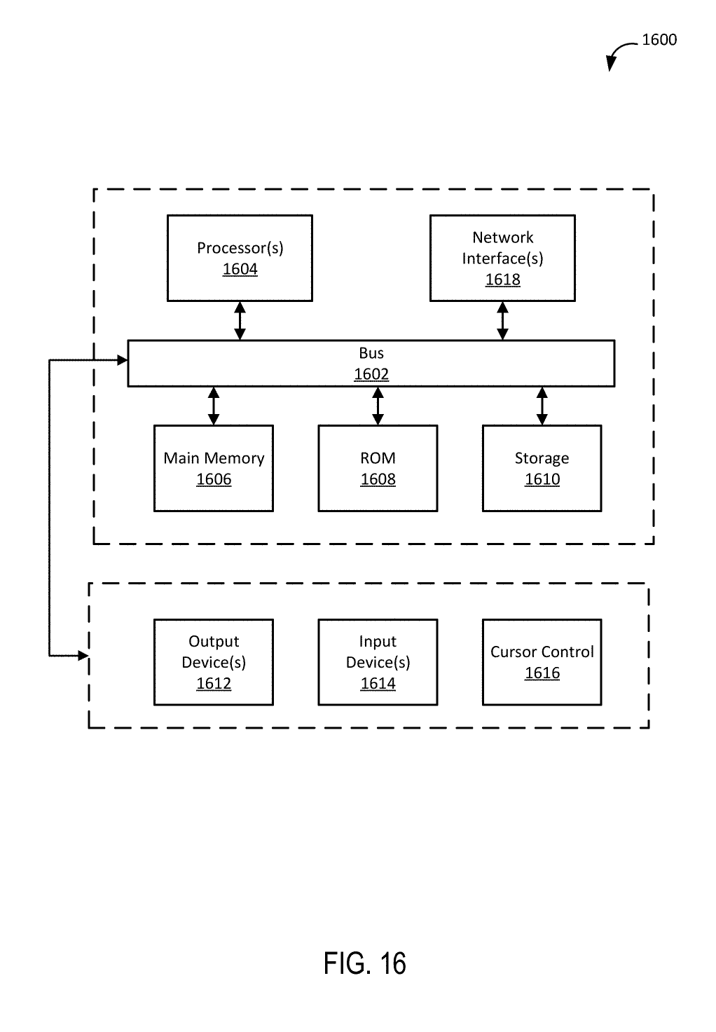

As is understood by skilled artisans in the relevant computer and Internet-related arts, each functional component (e.g., engine, module, or database) illustrated in FIG. 1 and the following figures (e.g., FIGS. 2, 3, 6, and 11) may be implemented using hardware (e.g., a processor of a machine) or a combination of logic (e.g., executable software instructions) and hardware (e.g., memory and processor of a machine) for executing the logic. Furthermore, the various functional components depicted in FIG. 1 and the following figures may reside on a single machine (e.g., a server) or may be distributed across several machines in various arrangements such as cloud-based architectures. Moreover, any two or more of these components may be combined into a single component (e.g., a single module), and the functions described herein for a single component may be subdivided among multiple engines. Specific hardware structure of the functional components illustrated in FIG. 1 and the following figures is exemplified with reference to FIG. 16.

FIG. 2 is an architecture diagram 200 illustrating a detailed structure of a regulation-compliant construction management server included in a construction project management system according to some embodiments. In the example shown in FIG. 2, a regulation-compliant construction management server 204 is connected to a network 202 and includes a communication interface engine 212, a GUI generation engine 214, a construction datastore management engine 216, and a construction datastore 218. In some embodiments, the network 202, the communication interface engine 212, the GUI generation engine 214, the construction datastore management engine 216, and the construction datastore 218 correspond to the network 102, the communication interface engine 112, the GUI generation engine 114, the construction datastore management engine 116, and the construction datastore 118 in FIG. 1.

In the example of FIG. 2, the construction datastore management engine 216 includes a worker service engine 220, an administrator service engine 222, and a property service engine 224 The worker service engine 220 may represent a functional module configured to manage a construction worker profile of a construction worker and worker GUIs associated with the construction worker. In some embodiments, the worker service engine 220 is configured to manage contents to be included in worker GUIs. For example, the worker service engine 220 may determine contents (e.g., status of certificates/licenses, course offers, today's construction sites, or the like) to be included in a worker GUI (e.g., a worker portal GUI). In some embodiments, the worker service engine 220 is configured to manage compliance with laws and/or regulatory rules associated with construction projects. For example, the worker service engine 220 may determine whether or not a construction worker has certificates/licenses required or recommended for a construction project assigned to the construction worker, and may cause a worker GUI to indicates compliance or incompliance with laws and/or regulatory rules.

In some embodiments, the worker service engine 220 is configured to manage and provide training and/or educational courses to renew or acquire certificates/licenses associated with construction work. For example, the worker service engine 220 may determine one or more training and/or educational courses proposed to a construction worker and may cause a worker GUI to indicate the proposed training and/or educational courses. In some embodiments, the worker service engine 220 is configured to manage assignments of construction projects. For example, the worker service engine 220 may determine one or more assignments to be worked on a day and may cause a worker GUI to indicate the one or more assignments. The worker service engine 220 may be configured to manage social network service (SNS)/news feeds related to construction work. For example, the worker service engine 220 may import SNS and/or news feeds from external online services, and/or provides a GUI for inputting internal SNS and/or news feeds.

The administrator service engine 222 may represent a functional module configured to manage a construction project profile of a construction project and project GUIs associated with the construction project and/or administrator GUIs. In some embodiments, the administrator service engine 222 is configured to manage contents to be included in project GUIs and/or administrator GUIs. For example, the administrator service engine 222 may determine contents (e.g., on-going project stats, past project stats, a geolocation map, or the like) to be included in an administrator GUI (e.g., an administrator portal GUI). In some embodiments, the administrator service engine 222 is configured to manage project assignment of construction projects. For example, the administrator service engine 222 may determine one or more candidate workers who possess certificates/licenses required or recommended for a construction project and are associated with a specific geographical area from registered workers and may cause an administrator GUI to indicate details of the one or more candidate workers.

The administrator service engine 222 may represent a functional module configured to manage a construction project profile of a construction project and project GUIs associated with the construction project and/or administrator GUIs. In some embodiments, the administrator service engine 222 is configured to manage contents to be included in project GUIs and/or administrator GUIs. For example, the administrator service engine 222 may determine contents (e.g., on-going project stats, past project stats, a geolocation map, or the like) to be included in an administrator GUI (e.g., an administrator portal GUI). In some embodiments, the administrator is configured for audit purposes of the construction projects. In one example, audit level users will be able to review items such as, but not limited to, on time, work completion, workflow, evidence. The administrator service engine 222 may provide user defined projects and/or select at random for user review. Through the administrator service engine 222, frequent violators of project factors (e.g., schedule, budget, and evidence) may be identified for review processes. In some embodiments, the administrator service engine 222 may be used to review any level of data in the system. For example, the audit process may be conducted on users, projects, types of projects, locations/regions of organizations.

The administrator service engine 222 may be configured to manage project progress of construction projects. For example, the administrator service engine 222 may determine a progress state (e.g., by percentage) of a construction project and whether or not a construction project is past due, and may cause an administrator GUI to indicate the progress state and a deadline state of construction projects. In some embodiments, the administrator service engine 222 is configured to manage statistics and rating related to construction projects. For example, the administrator service engine 222 may determine the number of on-going projects, the number of past-due projects, and the number of up-coming projects, and may cause an administrator GUI to visualize the determined numbers. In another example, the administrator service engine 222 may determine rating of a construction entity in comparison with other construction entities and/or rating of a construction worker in comparison with other construction workers and may cause an administrator GUI to visualize the rating comparison. In some embodiments, the administrator service engine 222 is configured to manage geolocation of construction projects. For example, the administrator service engine 222 may determine geographical locations of construction projects, and may cause an administrator GUI to indicate a geographical map of the construction projects.

The property service engine 224 may represent a functional module configured to manage a construction property profile of a property at which a construction project undergoes and property GUIs associated with the property. In some embodiments, the property service engine 224 is configured to manage contents to be included in property GUIs. For example, the property service engine 224 may determine contents (e.g., property details, construction project details, alerts associated with the construction projects). In some embodiments, the property service engine 224 is configured to manage project progress of construction projects. For example, the property service engine 224 may determine a progress state (e.g., by percentage) of a construction project and whether or not a construction project is past due, and may cause a property GUI to indicate the progress state and a deadline state of a construction project on the property. In some embodiments, the property service engine 224 is configured to manage a property owner's approval of a step of a construction project and/or the entire construction project. For example, the property service engine 224 may cause a GUI for a property owner to input signature (e.g., electronic signature) to be presented on a property owner terminal (e.g., the property owner terminal 110 in FIG. 1). In some embodiments, the property service engine 224 is configured to manage a property owner's rating of a construction project and/or one or more construction workers and one or more construction companies involved in the construction project. For example, the property service engine 224 may cause a GUI for a property owner to input rating (e.g., 1-5 out of) to be presented on a property owner terminal (e.g., the property owner terminal 110 in FIG. 1).

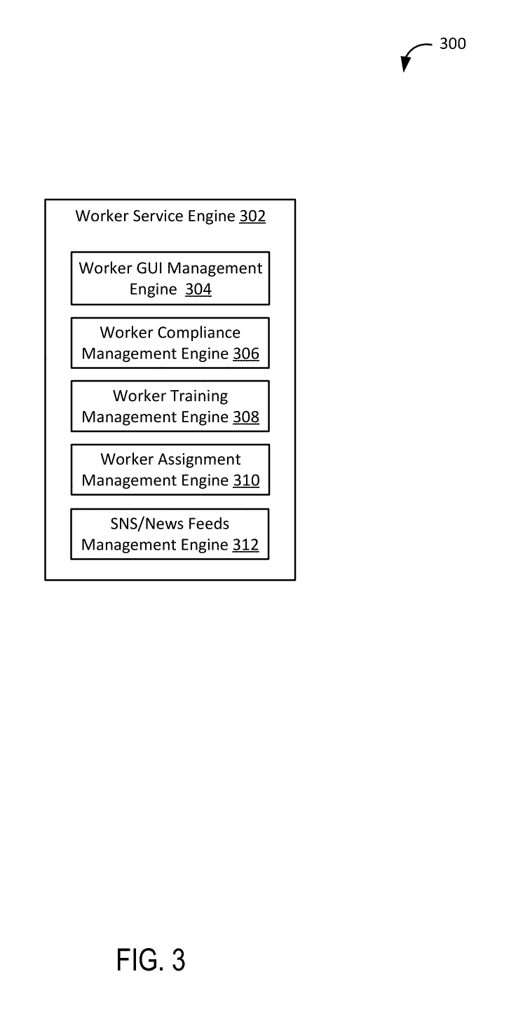

FIG. 3 is an architecture diagram 300 illustrating a detailed structure of a worker service engine according to some embodiments. In the example of FIG. 3, a worker service engine 302 includes a worker GUI management engine 304, a worker compliance management engine 306, a worker training management engine 308, a worker assignment management engine 310, and an SNS/news feeds management engine 312. The worker service engine 302 may correspond to the worker service engine 220 in FIG. 2. In some embodiments, the worker service engine 302 is configured to generate a construction worker profile of a construction worker upon registration of the construction worker to a construction project management system. The construction worker profile may include name and/or identifier of a construction worker, specialty of the worker (e.g., painter, plumber, welder, crane operator, or the like), geographic location (e.g., service area) of the worker, status of certifications/licenses related to construction projects and/or specific to the specialty, and states and details of construction project assigned to the worker. The registration of a construction worker may be performed through applicable terminals, such as the worker terminal 106 and/or the administrator terminal 108 in FIG. 1.

The worker GUI management engine 304 may represent a functional module configured to manage contents to be included in worker GUIs. In some embodiments, the worker GUI management engine 304 is configured to cause the worker GUIs to be presented to applicable terminal such as the worker terminal 106 in FIG. 1. A worker GUI may include statuses of certificates/licenses associated with construction work. For example, the worker GUI includes a list of certificates/licenses required or recommended to a construction worker. The list may include one or more certificates/licenses that are possessed by the construction worker and will not expire in a certain period (e.g., one month), one or more certificates/licenses that are possessed by the construction worker and will expire in a certain period (e.g., one month), and one or more certificates/licenses that are not possessed by the construction worker, in a distinguished manner. A specific example of a GUI caused to be presented by the worker GUI management engine 304 will be described with reference to FIG. 5.

In some embodiments, a worker GUI includes one or more training and/or educational course recommended to a construction worker. For example, the worker GUI includes a selectable object to present a training and/or educational course, and upon selection of the selectable object, the worker GUI is caused to transition to a training GUI to take the corresponding training and/or educational course. In some embodiments, a worker GUI includes statuses of one or more training and/or educational courses that are currently taken by a construction worker. For example, the worker GUI includes a list of the one or more training and/or educational courses that are currently taken and indicates a progress state of the courses.

In some embodiments, a worker GUI includes statuses of assigned construction project to be worked on a given day. For example, the worker GUI may include a presentation region indicating a type of assignments to be performed by a construction worker, a status of the assignments, and a geographical location of a property at which the work is to be performed. In some embodiments, a worker GUI includes a time frame calendar of a given day, month, and/or year, indicating specific time (time in a day, day, and/or month) at which one or more assignments to be performed by the construction worker.

A worker GUI may include a selectable object to transition to project GUIs for construction projects that are assigned to the corresponding worker.

The worker compliance management engine 306 may represent a functional module configured to manage compliance with laws and/or regulatory rules associated with construction projects. In some embodiments, the worker compliance management engine 306 is configured to determine required or recommended certifications/licenses for a construction worker to work on construction project assignments. For example, the worker compliance management engine 306 may determine that an HVAC (heating, ventilation, and air conditioning) certificate is required or recommended for an air conditioning and heat-insulation work assignment. In another example, the worker compliance management engine 306 may determine that a fire safety worker certificate is required or recommended for a heating and ventilation work assignment. In still another example, the worker compliance management engine 306 may determine that an electrical safety certification is required or recommended for lighting and wiring work assignment. In yet another example, the worker compliance management engine 306 may determine that a crane operation license is required for operating a crane in a frame assembling assignment.

In some embodiments, the worker compliance management engine 306 is configured to determine whether or not a construction worker has required or recommended certifications/licenses. For example, the worker compliance management engine 306 may determine that a construction worker does not have required or recommended certifications/licenses, when a construction worker profile of the construction worker indicates non-possession or expiration of the required or recommended certifications/licenses. In another example, the worker compliance management engine 306 may determine that a construction worker has required or recommended certifications/licenses, when a construction worker profile of the construction worker indicates possession the required or recommended certifications/licenses that have not expired. In some embodiments, copies or pictures of certifications/licenses are uploaded to a construction project management system so as to be included in a construction worker profile.

In some embodiments, the worker compliance management engine 306 is configured to determine expiration dates of worker's required or recommended certifications/licenses. For example, the worker compliance management engine 306 may determine an expiration date based on applicable sources such as indication on a certification/license included in a construction worker profile, the last renew date or an issue date recorded on a construction worker profile as a result of taking a training course through a construction project management system, and so on. In another example, the worker compliance management engine 306 may determine an expiration date based on an annuity due date, if a certification/license requires annuity payment although it does not require continued education or training.

In some embodiments, the worker compliance management engine 306 is configured to update status of worker's required or recommended certifications/licenses recorded on a construction worker profile. For example, the worker compliance management engine 306 updates a status of a certification/license as being possessed by the worker upon upload of a copied image of the certification/license. In another example, the worker compliance management engine 306 updates a status of a certification/license as being possessed upon completion of a training course by the worker. In yet another example, the worker compliance management engine 306 updates a status of a certification/license as being expiring soon upon an expiration date of the certification/license being within a certain period (e.g., one month). In still another example, the worker compliance management engine 306 updates a status of a certification/license as being expired upon passing an expiration date of the certification/license and with no renew or annuity payment thereof.

The worker training management engine 308 may represent a functional module configured to manage and provide training and/or educational courses to renew or acquire certificates/licenses associated with construction work. In some embodiments, the worker training management engine 308 is configured to maintain and update training and/or educational courses associated with construction work in datastore such as the construction datastore 218 in FIG. 2. For example, the worker training management engine 308 adds a new training and/or educational course required or recommended for a construction work associated with a new law or regulatory rule. In another example, the worker training management engine 308 removes a training and/or educational course that is no longer compliant with a new law or regulatory rule. In still another example, the worker training management engine 308 modifies a training and/or educational course so as to be compliant with a new law or regulatory rule.

In some embodiments, the worker training management engine 308 is configured to determine one or more training and/or educational courses to be offered to a construction worker, based on missing and/or expiring certificates/licenses indicated in a construction worker profile recorded in a construction project management system. For example, the worker training management engine 308 may determine an HVAC certificate training to be offered, when a construction worker profile indicates that an HVAC certificate is missing or has expired. In another example, the worker training management engine 308 may determine a fire safety certificate training to be offered, when a construction worker profile indicates that a fire safety certificate is missing or has expired. In some embodiments, the worker training management engine 308 is configured to offer one or more training and/or educational courses that are determined to be offered to a worker. For example, the worker training management engine 308 may request the worker GUI management engine 304 to cause a GUI for offering training and/or educational courses to be presented on an applicable terminal such as the worker terminal 106 in FIG. 1. It will be appreciated that the GUI for offering training and/or educational courses may include a selectable object to take or start a course.

In some embodiments, the worker training management engine 308 is configured to provide a training and/or educational course that is selected by a worker through a GUI for offering training and/or educational courses. For example, the worker training management engine 308 may request the worker GUI management engine 304 to cause one or more training GUIs for taking the training and/or educational course to be presented. The training GUIs may include various applicable materials, such as documents, video presentation, presentation slides, audio presentation, quiz, exam and so on. In another some embodiments, the training GUIs may include communication tool for communicating with instructors and/or tutors, chatting with other course takers, and so on.

The worker assignment management engine 310 may represent a functional module configured to manage assignments of construction projects. In some embodiments, the worker assignment management engine 310 is configured to determine one or more construction work assignments to be worked on a certain time period such as day, week, month, and so on. For example, the worker assignment management engine 310 may determine scheduled time of construction work assignments from construction project profiles thereof recorded in a construction project management system, and selects construction work assignments for which scheduled time is within the certain time period. In some embodiments, the worker assignment management engine 310 is configured to request the worker GUI management engine 304 to cause a GUI for indicating the construction work assignments to be presented on an applicable terminal such as the worker terminal 106 in FIG. 1.

In some embodiments, the worker assignment management engine 310 is configured to request the worker GUI management engine 304 to cause a GUI for inputting evidence of completion of a step of a construction work assignment to be presented on an applicable terminal such as the worker terminal 106 in FIG. 1. For example, the evidence may include a picture of a construction site and/or measurement of a construction material included in the picture. In another example, the evidence may include video clip recording a regulatory construction work step performed by the worker.

The SNS/news feeds management engine 312 may represent a functional module configured to manage social network service (SNS)/news feeds related to construction work. In some embodiments, the SNS/news feeds management engine 312 is configured to obtain SNS/news feeds related to construction work from external sources including external news sites and external SNS sites and SNS/news feeds input by registered workers, and select SNS/news feeds associated with a worker based on applicable attribute included in a construction worker profile thereof. For example, the SNS/news feeds management engine 312 selects SNS/news feeds related to new regulatory rules associated with specialty (e.g., painting, plumbing, or the like) of the worker, SNS/news feeds related to associated with the specialty, and so on. For example, the SNS/news feeds management engine 312 selects SNS/news feeds made by workers in the same entity, the same geographic region, and/or the same construction project. In some embodiments, the SNS/news feeds management engine 312 is configured to request the worker GUI management engine 304 to cause a GUI for presenting the selected SNS/news feeds to be presented on an applicable terminal such as the worker terminal 106 in FIG. 1. The GUI may also allow the worker to input a SNS/news feed to be distributed to other workers.

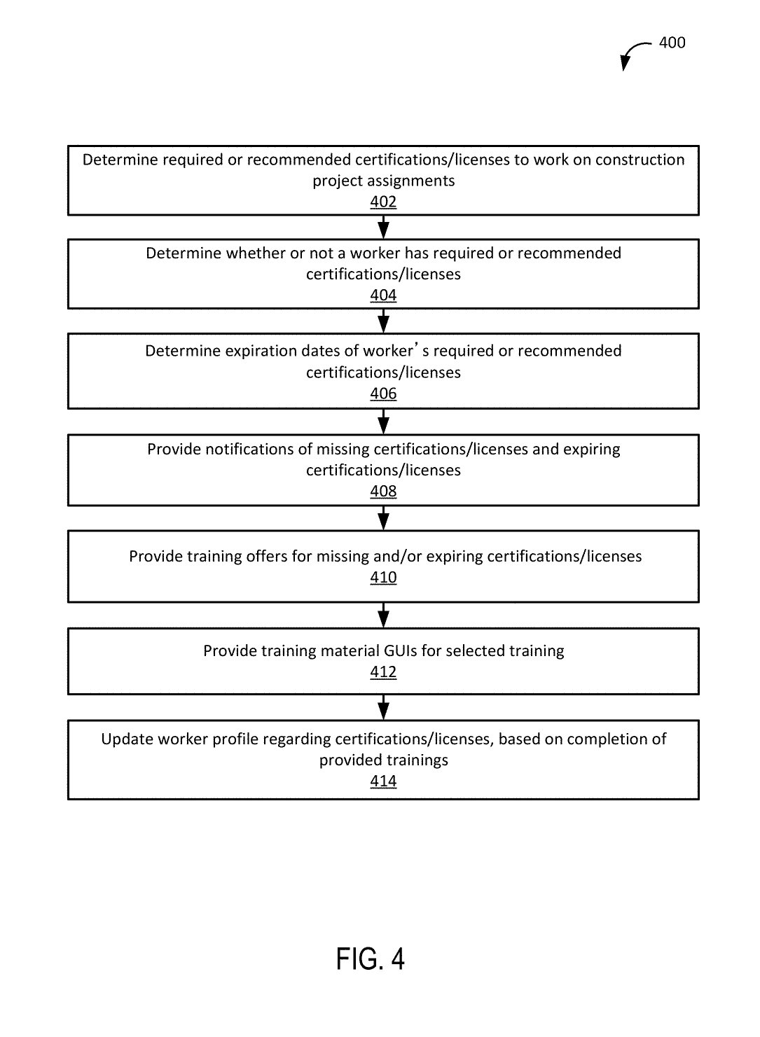

FIG. 4 is a flowchart of an example of a method for managing a construction worker profile according to some embodiments. This flowchart described in this paper illustrate modules (and potentially decision points) organized in a fashion that is conducive to understanding. It should be recognized, however, that the modules can be reorganized for parallel execution, reordered, modified (changed, removed, or augmented), where circumstances permit.

In module 402 of FIG. 4, required or recommended certifications/licenses for construction project assignments are determined. An applicable engine such as the worker compliance management engine 306 in FIG. 3 may determine the required or recommended certifications/licenses for construction project assignments. In some embodiments, the required or recommended certifications/licenses are determined based on information in a construction worker profile and construction project profiles of assigned projects.

In module 404 of FIG. 4, whether or not a worker has required or recommended certifications/licenses is determined. An applicable engine such as the worker compliance management engine 306 in FIG. 3 may determine whether or not the worker has required or recommended certifications/licenses. In some embodiments, possession of the required or recommended certifications/licenses is determined based on information in a construction worker profile.

In module 406 of FIG. 4, expiration dates of worker's required or recommended certifications/licenses are determined. An applicable engine such as the worker compliance management engine 306 in FIG. 3 may determine expiration dates of worker's required or recommended certifications/licenses. In some embodiments, the expiration dates of worker's required or recommended certifications/licenses is determined based on information in a construction worker profile.

In module 408 of FIG. 4, notifications of missing certifications/licenses and expiring certifications/licenses are provided. An applicable engine such as the worker GUI management engine 304 in FIG. 3 and/or the GUI generation engine 214 in FIG. 2 provides notifications of missing certifications/licenses and expiring certifications/licenses, by causing a GUI including the notification to be presented to an applicable terminal such as the worker terminal 106 in FIG. 1.

In module 410 of FIG. 4, training offers for missing and/or expiring certifications/licenses are provided. An applicable engine such as the worker training management engine 308 in FIG. 3 and/or the GUI generation engine 214 in FIG. 2 may cause provision of training offers for missing and/or expiring certifications/licenses, by causing a GUI including the training offers to be presented to an applicable terminal such as the worker terminal 106 in FIG. 1.

In module 412 of FIG. 4, training material GUIs for selected training for selected training is provided. An applicable engine such as the worker training management engine 308 in FIG. 3 and/or the GUI generation engine 214 in FIG. 2 may cause provision of training material GUIs for selected training, by causing the training material GUIs to be presented to an applicable terminal such as the worker terminal 106 in FIG. 1.

In module 414 of FIG. 4, construction worker profiles regarding certifications/licenses are updated based on completion of provided trainings. An applicable engine such as the worker compliance management engine 306 in FIG. 3 updates a construction worker profile regarding certifications/licenses and may cause a worker GUI to indicate an updated status of certifications/licenses and to be presented to an applicable terminal such as the worker terminal 106 in FIG. 1.

FIG. 5 is a diagram 500 illustrating an example of a graphical user interface (GUI) for providing project management service to workers and managing construction worker profiles according to some embodiments. The GUI illustrated in FIG. 5 includes a navigation bar 502, a daily summary window 504, a daily site visit summary window 506, a calendar window 508, a certification list window 510, an SNS/news feed window 512, a course recommendation window 514, and an on-going course window 516. In some embodiments, the GUI in FIG. 5 corresponds to a worker portal GUI. Each of the windows 504-516 also includes an individual navigation bar at the top of the window to allow for specific setting of the window.

In the example of FIG. 5, the navigation bar 502 includes a search box, selectable objects to access reminders, notifications, and alerts. The navigation bar 502 also includes a selectable object to set up worker account information, such as name, address, specialty, geographical service area, certificates/licenses, etc.

The daily summary window 504 includes a daily summary of a worker, such as projects to be worked on, expired and/or expiring certificate/licenses.

The daily site visit summary window 506 includes details of properties associated with today's construction assignments, such as address, property owner's name, a type of the assignment, progress and/or on-schedule status of the assignment.

The calendar window 508 includes a time frame schedules to be performed on a specific time period, such as day, week, month, year, etc. In some embodiments, the specific time period is changeable based on user setting.

The certification list window 510 includes one or more certificate/licenses that are possessed by a worker, and status (e.g., valid, expired, expiring) and expiration date of the certificate/licenses.

The SNS/news feed window 512 includes one or more SNS/news feeds uniquely associated with the worker. For example, posts by workers of the same construction entity and news feeds related to specialty of construction work and/or geographical locations are listed in the SNS/news feed window 512.

The course recommendation window 514 includes a title of an offered course and details description of the offered course. In some embodiments, the course recommendation window 514 includes a selectable object to transition to a training GUI to start the offered course.

The on-going course window 516 includes a list of current courses that are taken by the worker, and a title and a progress state with respect to each of the current courses.

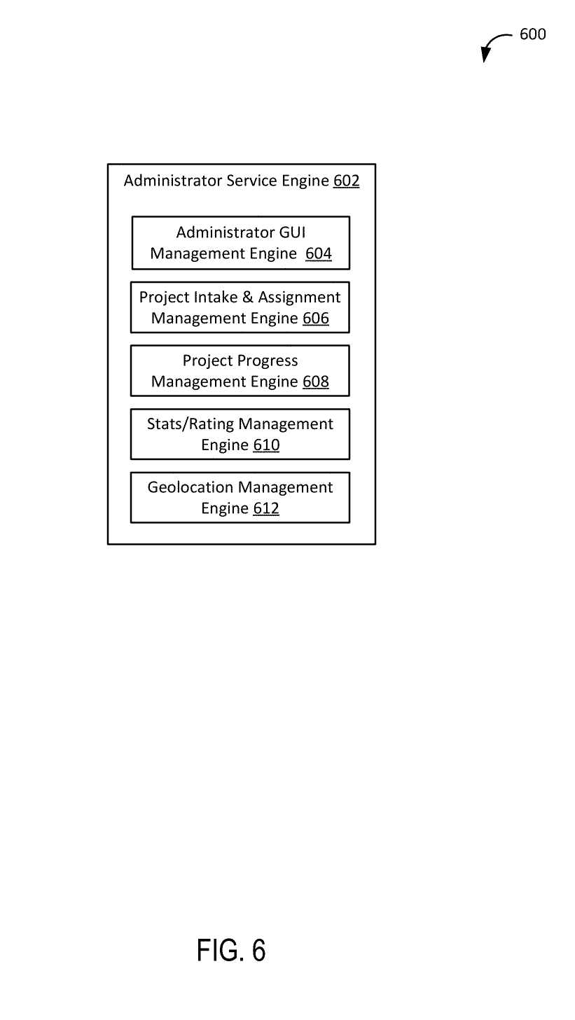

FIG. 6 is an architecture diagram 600 illustrating a detailed structure of an administrator service engine according to some embodiments. In the example of FIG. 6, an administrator service engine 602 includes an administrator GUI management engine 604, a project assignment management engine 606, a project progress management engine 608, a stats/rating management engine 610, and a geolocation management engine 612. In some embodiments, the administrator service engine 602 corresponds to the administrator service engine 222 in FIG. 2.

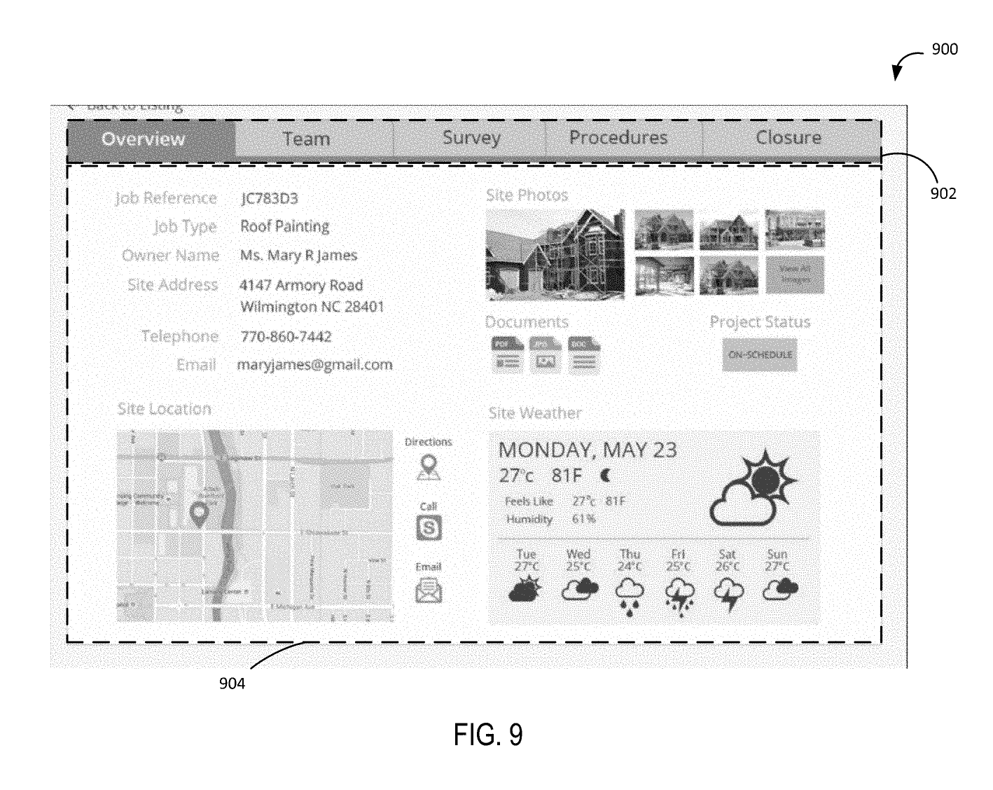

In the example of FIG. 6, the administrator GUI management engine 604 may represent a functional module configured to manage contents to be included in project GUIs and/or administrator GUIs. A specific example of a GUI caused to be presented by the administrator GUI management engine 604 will be described with reference to FIGS. 9, 10, and 11. In some embodiments, the administrator GUI management engine 604 is configured to cause the project GUIs to be presented to applicable terminals such as the administrator terminal 108 in FIG. 1. A project GUI may include a type of construction project (e.g., painting, plumbing, carpet flooring, room restructuring, or the like), a construction year of a property, a geographical location of the property, a geographical map of the property, pictures of the property, a progress status of the project, and so on. In some embodiments, a project GUI includes a list of candidate workers that possess certificates/licenses required or recommended for the construction project. A project GUI may include a property survey GUI to be filled in by a worker. For example, the property survey GUI includes inquiry about built year, occupants details (e.g., age), budgets, renovation history, etc.

The administrator GUI management engine 604 may be configured to cause the administrator GUIs to be presented to applicable terminals such as the administrator terminal 108 in FIG. 1. In some embodiments, an administrator GUI includes on-going construction project stats, up-coming construction project stats, contractor comparison and rating stats, construction worker stats, a project geolocation map, and so on associated with a specific construction entity. For example, the on-going construction project stats may include the total number of on-going construction projects, the number of on-schedule projects, the number of overdue projects. The up-coming construction project stats may include the number of upcoming projects, the number of upcoming projects involving regulated materials (e.g., lead, asbestos) in comparison to the number of upcoming projects not involving the regulated materials, and so on. The contractor comparison and rating stats may include the number of certified workers in comparison to the number of uncertified workers.

The project intake and assignment management engine 606 may represent a functional module configured to manage project assignment of construction projects. In some embodiments, the project intake and assignment management engine 606 is configured to generate a construction project profile of a construction project upon registration of a construction project to a construction project management system. In some embodiment, the construction project profile includes a type of construction project (e.g., painting, plumbing, carpet flooring, room restructuring, or the like), a construction year of a property, a geographical location of the property, construction materials and/or tools to be used, a budget, a due date, and so on. In some embodiments, the registration of a construction project may be performed through applicable terminals, such as the worker terminal 106, the administrator terminal 108, and/or the property owner terminal 110 in FIG. 1.

In some embodiments, the project intake and assignment management engine 606 is configured to determine project details of the new project based on inputs. For example, the project details may include the type of construction project, the construction year of a property, the geographical location of the property, the construction materials and/or tools to be used, the budget, the due date, and so on, which are imported to the construction project profile. The inputs may be made through applicable terminals, such as the worker terminal 106, the administrator terminal 108, and/or the property owner terminal 110 in FIG. 1. In some embodiments, the project intake and assignment management engine 606 is configured to determine required or recommended regulatory process for the new project based on the project details. For example, the project intake and assignment management engine 606 may determine that a lead painting and asbestos removal is required for a property older than certain construction year and meeting certain conditions (e.g., child-occupancy). In another example, the project intake and assignment management engine 606 may determine that an employee safety training is required to handle certain hazardous materials.

In some embodiments, the project intake and assignment management engine 606 is configured to determine required or recommended worker's certificates/licenses for the required or recommended regulatory process and the project details. For example, the project intake and assignment management engine 606 may determine that a fire safety certificate is required or recommended for a HVAC work. In another example, the project intake and assignment management engine 606 may determine that an RRP (renovation, repair, painting) certificate is required for the required or recommended regulatory process.

In some embodiments, the project intake and assignment management engine 606 is configured to determine candidate workers for the new project based on required or recommended certificates/licenses and certificates/licenses possessed by registered workers. For example, the project intake and assignment management engine 606 selects one or more workers whose construction worker profiles indicate matching specialty, geographical location, certificates/licenses, schedule, and so on. In some embodiments, the project intake and assignment management engine 606 is configured to determine workers to whom the new project is assigned from candidate workers, and assign the new project to the determined workers. For example, the project intake and assignment management engine 606 may determine workers to whom the new project is assigned based on input made on a project GUI including a list of candidate workers each of which is selectable, which is caused to be generated by the administrator GUI management engine 604. The project intake and assignment management engine 606 may add the assigned workers to a construction project profile of the new project to assign the new project to the workers. In some embodiments, once the construction project profile is updated to include the assigned workers, construction worker profiles of the assigned workers are also updated to include the assigned work in an assignment list.

The project intake and assignment management engine 606 may be configured to determine workflow for a new project based on project details and required or recommended regulatory process for the new project. For example, the project intake and assignment management engine 606 may determine substantial steps for construction based on the type of project, a preliminary step (e.g., safety confirmation) to be performed before the substantial steps for construction, a regulatory process to be performed in the midst of the substantial steps, an inspection process to be performed between the substantial steps, and so on.

The project progress management engine 608 may represent a functional module configured to manage project progress of construction projects. In some embodiments, the project progress management engine 608 is configured to determine a progress state of a construction project based on completion of steps in a workflow of the project. The project progress management engine 608 may cause an on-schedule state to on-schedule if a current day has not passed an expected completion day, which may be indicated in a construction project profile, and to overdue if a current day has passed an expected completion day.

In some embodiments, the project progress management engine 608 is configured to perform validation of the evidence inputs, for example, in order to validate completion of a step of a workflow. For example, the evidence inputs (e.g., photo images) may be an on-site input from applicable terminals, such as the worker terminal 106 in FIG. 1, and the project progress management engine 608 analyzes contents (e.g., image data) and metadata (e.g., date, geographical location, author, author signature, or the like) of the evidence inputs to validate completion of the step of the workflow. In some embodiments, the project progress management engine 608 is configured to perform the validation with respect to one or more (e.g., all) steps of a workflow and disable validation of subsequent step(s) until validation of a step of the workflow. The project progress management engine 608 may be configured to disable validation of completion of a step of the workflow when the evidence input is associated with (e.g., made by) a worker whose construction worker profile indicates lack of a certificate or a license required to perform the step. In some embodiments, the project progress management engine 608 is configured to determine that a construction project is completed, when all validation processes for the one or more steps of a workflow are successfully completed and an owner's approval input is received. For example, the project progress management engine 608 enables approval of completion of the construction project based on a signature input, upon validation of a last step of the workflow. For example, the owner's approval input (e.g., owner's handwritten e-signature) may be input from applicable terminals, such as the worker terminal 106 and/or the owner property terminal 110 in FIG. 1.

In some embodiments, the project progress management engine 608 is configured to update a construction project profile of a construction project and construction worker profiles of one or more workers involved in the construction project, upon completion of the project. For example, the project progress management engine 608 updates a construction project profile as being completed and may request the stats/rating management engine 610 that an administrator GUI reflects completion of the project (e.g., removal from on-going project stats). In another example, the progress management engine 608 updates a construction worker profile such that the project is removed from an assignment list and included in a project history or an automatically-generated e-resume of the corresponding worker.

The stats/rating management engine 610 may represent a functional module configured to manage statistics and rating related to construction projects. In some embodiments, the stats/rating management engine 610 is configured to generate statistic data of construction projects and construction workers based on construction project profiles and construction worker profiles. For example, the stats/rating management engine 610 calculates the number of on-going projects, the number of overdue projects, the number of certified workers, the number of uncertified workers, the type of projects in terms of necessity of regulatory process, and so on, which are caused to be included in an administrator GUI by the administrator GUI management engine 604. In some embodiments, the stats/rating management engine 610 is configured to generate rating data of construction projects and construction workers based on construction project profiles and construction worker profiles, which may include rating inputs from property owners. For example, the stats/rating management engine 610 calculates an average rating value for respective construction companies, respective construction workers, and so on, which are caused to be included in an administrator GUI by the administrator GUI management engine 604.

The geolocation management engine 612 may represent a functional module configured to manage geolocation of construction projects. In some embodiments, the geolocation management engine 612 is configured to determine geographic locations of construction projects associated with a construction entity and generate map data for a map to indicate the geographic locations of the construction projects. In some embodiments, the map is caused to be included in an administrator GUI by the administrator GUI management engine 604.

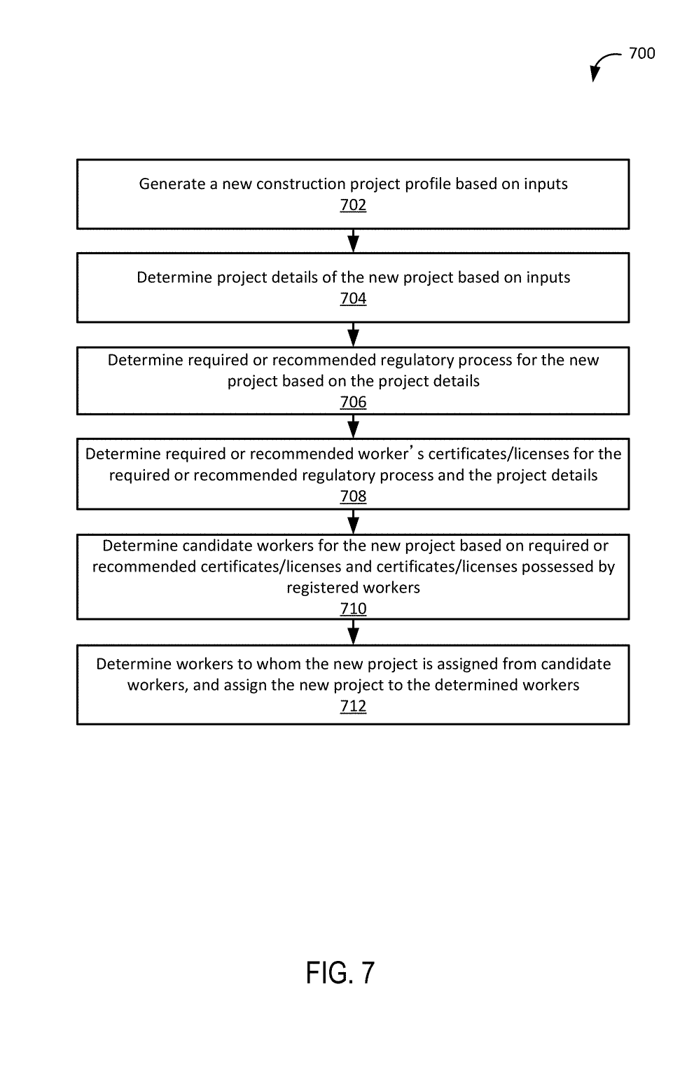

FIG. 7 is a flowchart 700 of an example of a method for managing a construction project profile according to some embodiments. In module 702 of FIG. 7, a new construction project profile is generated based on inputs. An applicable engine such as the project intake and assignment management engine 606 in FIG. 6 generates a new construction project profile. In some embodiments, the generated construction project profile may not include some information when generated and may be added subsequently upon various applicable events, such as project detail inputs, worker assignments, property survey inputs, evidence inputs, and so on.

In module 704 of FIG. 7, project details of the new construction project are determined based on inputs. An applicable engine such as the project intake and assignment management engine 606 in FIG. 6 may determine the project details of the new construction project, for example, based on project detail inputs and/or property survey inputs.

In module 706 of FIG. 7, required or recommended regulatory process for the new project is determined based on the project details. An applicable engine such as the project intake and assignment management engine 606 in FIG. 6 may determine the required or recommended regulatory process for the new project.

In module 708 of FIG. 7, required or recommended worker's certificates/licenses for the required or recommended regulatory process and the project details are determined. An applicable engine such as the project intake and assignment management engine 606 in FIG. 6 may determine the required or recommended worker's certificates/licenses for the required or recommended regulatory process and the project details. In some embodiments, an archive of laws and/or regulations related to construction work is retrieved from applicable source such as the construction datastore 218 in FIG. 2, and the required or recommended worker's certificates/licenses are determined based thereon.

In module 710 of FIG. 7, candidate workers for the new project are determined based on required or recommended certificates/licenses and certificates/licenses possessed by registered workers. An applicable engine such as the project intake and assignment management engine 606 in FIG. 6 may determine the candidate workers for the new project. In some embodiments, workers whose construction worker profiles include matching specialty, geographical location, certificates/licenses, schedule may be selected as the candidate workers.

In module 712 of FIG. 7, workers to which the new project is assigned are determined from candidate workers, and the new project is assigned to the determined workers. An applicable engine such as the project intake and assignment management engine 606 in FIG. 6 assigns the new project to one or more construction workers registered to a construction project management system (e.g., the construction project management system in FIG. 1). For example, construction worker profiles of the assigned workers are updated to be associated with the construction project profile of the new project.

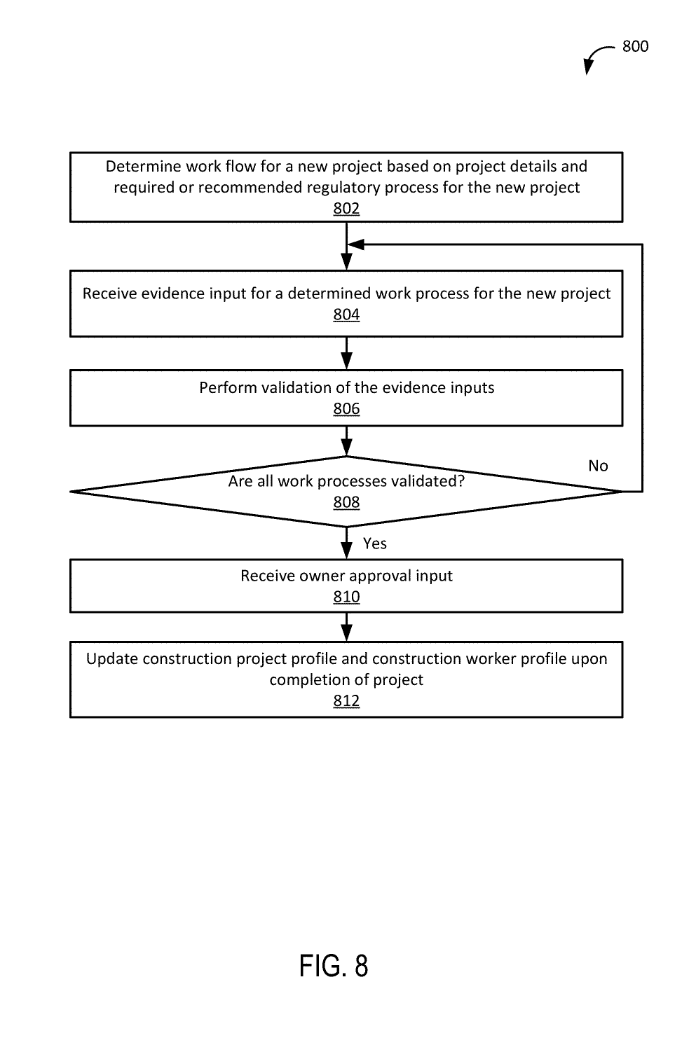

FIG. 8 is a flowchart 800 of another example of a method for managing a construction project profile according to some embodiments. In module 802 of FIG. 8, workflow for a new project is determined based on project details and required or recommended regulatory process for the new project. An applicable engine such as the project intake and assignment management engine 606 in FIG. 6 may determine the workflow for the new project, for example, based on project details, property survey results, required or recommended regulatory procedures included in or associated with the construction project profile.

In module 804 of FIG. 8, evidence input for a determined work process for the new project is received. An applicable engine such as the administrator GUI management engine 604 in FIG. 6 and/or the GUI generation engine 214 in FIG. 2 may cause a GUI for inputting the evidence to be presented to an applicable terminal such as the worker terminal 106 and/or the property owner terminal 110 in FIG. 1, and an applicable engine such as the project progress management engine 608 in FIG. 6 receives the evidence input for the work process for the new project.

In module 806 of FIG. 8, validation of the evidence entry is performed. An applicable engine such as the project progress management engine 608 in FIG. 6 performs validation of the evidence entry. In some embodiments, the validation is performed through automatic computer-based image analysis of evidence images and metadata analysis of the evidence images.

In decision point 808 of FIG. 8, it is determined whether or not all work processes are validated. An applicable engine such as the project progress management engine 608 in FIG. 6 may determine whether or not all work processes are validated. When it is determined that all work processes are validated, the flowchart 800 proceeds to module 810; when it is determined that all work processes are not validated, the flowchart 800 returns to module 804.

The system, through the GUI may place a geographic limitation (e.g., user defined limitations) on the property location. The geographical limitation may act as a threshold for the completion of work on a given property. If the work process is completed within the geographical limitation the work input will process as within boundary. If the work violates the geographical limitations of the property address, a conflict notification may be produced by the GUI and the notification may be sent to the applicable terminal(s).

In module 810 of FIG. 8, owner approval input is received. An applicable engine such as the administrator GUI management engine 604 in FIG. 6 and/or the GUI generation engine 214 in FIG. 2 may cause a GUI for inputting the owner approval to be presented to an applicable terminal such as the worker terminal 106 and/or the property owner terminal 110 in FIG. 1, and an applicable engine such as the project progress management engine 608 in FIG. 6 receives the owner approval input.

In module 812 of FIG. 8, a construction project profile and a construction worker profile are updated upon completion of project. An applicable engine such as the project progress management engine 608 in FIG. 6 updates the construction project profile and the construction worker profile, and an applicable engine such as the administrator GUI management engine 604 in FIG. 6 and/or the GUI generation engine 214 in FIG. 2 may cause an administrator GUI to indicate an updated project stats reflecting the construction project profile and the construction worker profile and to be presented to an applicable terminal such as the administrator terminal 108 in FIG. 1.

FIG. 9 is a diagram 900 illustrating an example of a GUI for providing project and worker management service to administrators according to some embodiments. The GUI illustrated in FIG. 9 includes a navigation bar 902 and a main presentation window 904. In some embodiments, the GUI in FIG. 9 corresponds to a project GUI. In the example of FIG. 9, the navigation bar 902 incudes a plurality of selectable tabs, and the main presentation window 904 presents information corresponding to a selected one of the selectable tabs. The plurality of selectable tabs, for example, include overview, team, survey, procedures, and closure as shown. The team tab may be used to select workers to whom the construction project is assigned. The survey tab may be used to input or review survey information. The procedures tab may be used to determine or review a workflow of the construction project. The closure tab may be used to complete the construction project.

The main presentation window 904 is configured to present detailed information associated with the selected tab. When the overview tab is selected, the main presentation window 904 presents address, property owner's information, map, pictures of a property, progress state of a construction project, and weather in a region of the property.

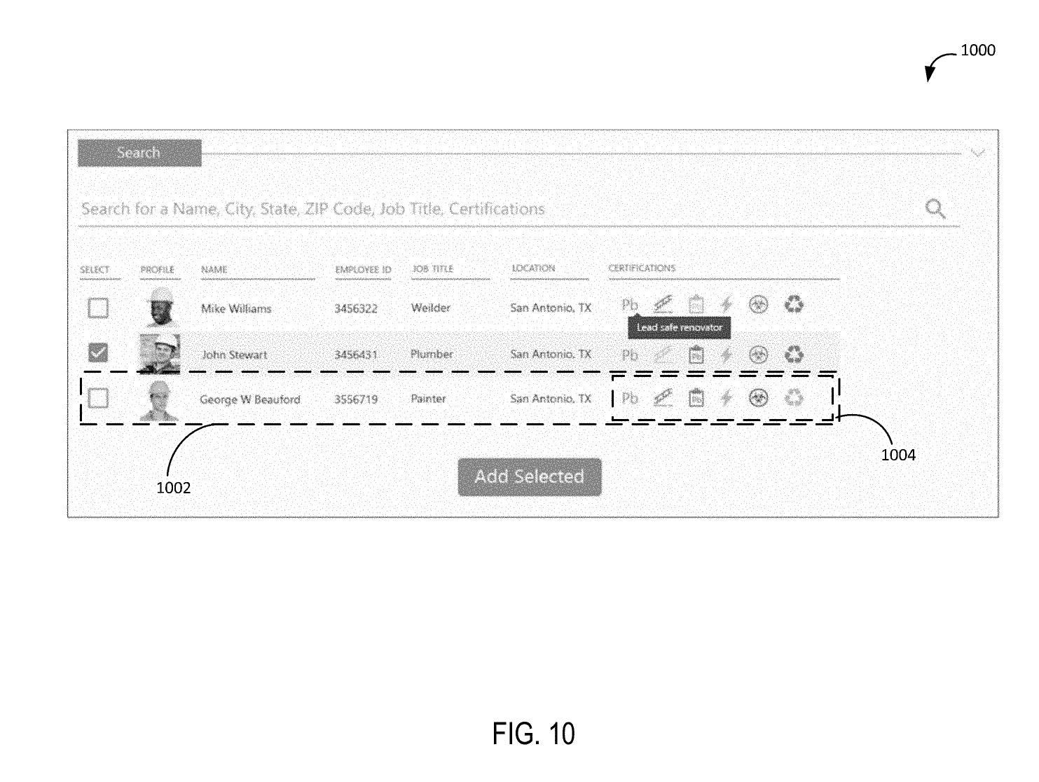

FIG. 10 is a diagram 1000 illustrating an example of a GUI for providing project and worker management service to administrators according to some embodiments. The GUI illustrated in FIG. 10 includes a list of candidate worker entries 1002 and each candidate worker entry includes indicators 1004 of statuses of certificates/licenses associated with the candidate worker. In some embodiments, the GUI in FIG. 10 corresponds to a project GUI and can be navigated from the GUI in FIG. 9 by selecting the team tab.

In some embodiments, the indicators 1004 include a plurality of indicators corresponding to different certificates/licenses, respectively. In one example, the indicators 1004 include a certificate for handling lead-containing materials, an electrician certificate, a certificate for handling bio-hazard materials, a certificate for handling recyclable materials. Different statuses of a certificate/license may be indicated by different colors of the corresponding indicator. In some examples, a red indicator indicates an expired status, a yellow indicator indicates an expiring status, a green indicator indicates a valid status.

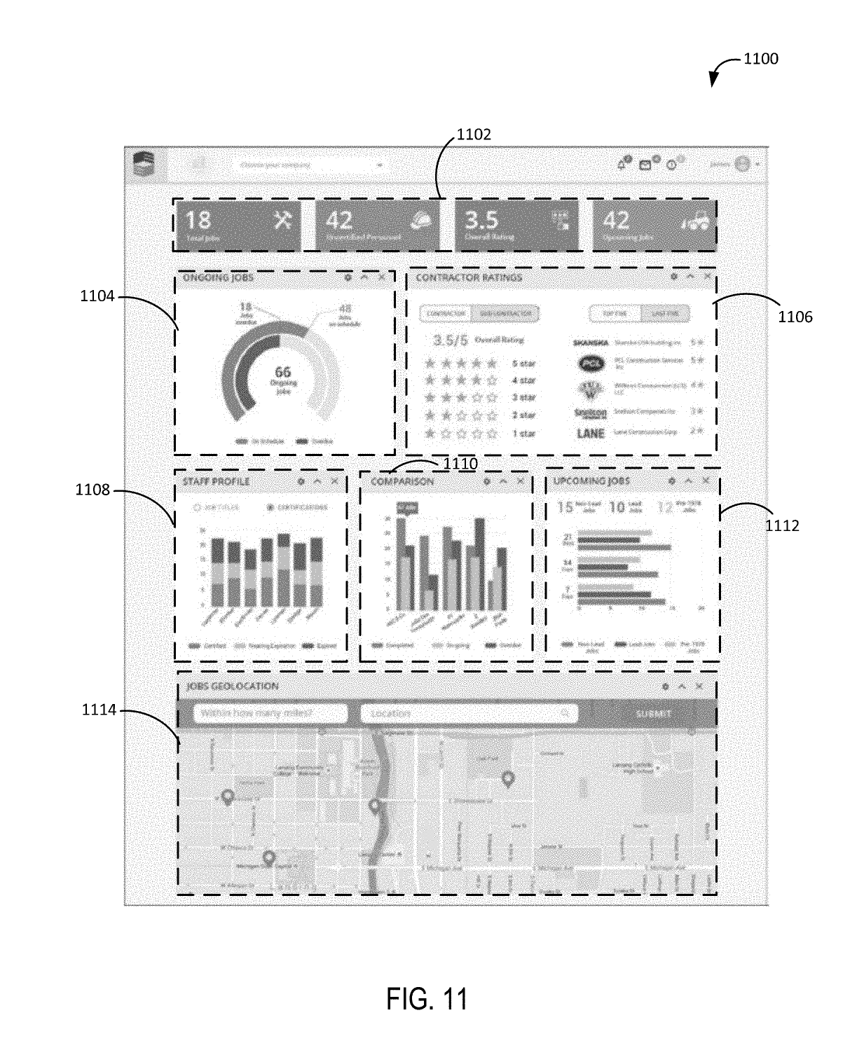

FIG. 11 is a diagram 1100 illustrating an example of a GUI for providing project and worker management service to administrators according to some embodiments. The GUI illustrated in FIG. 11 includes an entity summary window 1102, an on-going project stats window 1104, an entity rating window 1106, a worker stats window 1108, an entity comparison window 1110, an upcoming project stats window 1112, and a geolocation map window 1114. In some embodiments, the GUI in FIG. 11 corresponds to an administrator portal GUI associated with a specific construction entity (e.g., general constructor, contractor, subcontractor, or the like). The GUI and each of the windows 1104-1114 include an individual navigation bar at the top thereof allow for specific setting.

In the example of FIG. 11, the entity summary window 1102 includes visual presentations of the total number of on-going construction projects, the number of uncertified workers, a rating of the construction entity, and the number of upcoming projects.

The on-going project stats window 1104 includes visual presentations (e.g., graph) of the number of on-schedule construction projects and the number of overdue construction projects.

The entity rating window 1106 includes visual presentations of an average rating value of construction entities (e.g., contractors, sub-contractors) by type of the entities, and a ranking list of top rated entities in the type.

The worker stats window 1108 includes visual presentations (e.g., graph) of the number of certified, uncertified (expired), and expiring workers by specialty of work. The specialty includes carpenter, plumber, electrician, fencer, linemen, dredger, mason, and etc. For example, the visual presentation distinguishes different statuses of the certificate/license by different colors.

The entity comparison window 1110 includes visual presentations (e.g., graph) of the numbers of completed projects, on-going projects, and overdue projects for each of a plurality of entities. For example, the visual presentation distinguishes the different progress states of the projects by different colors.

The upcoming project stats window 1112 includes visual presentations (e.g., graph) of the numbers of lead-involving projects, non-lead-involving projects, and projects on pre-1978 property handled by the entity, for each of different periods till due dates. For example, the visual presentation distinguishes the different types of projects by different colors.

The geolocation map window 1114 includes visual presentations (e.g., map) indicating locations of construction projects handled by the entity by plots in the visual presentations. Selection of plot may navigate the GUI to a project GUI of the selected project.

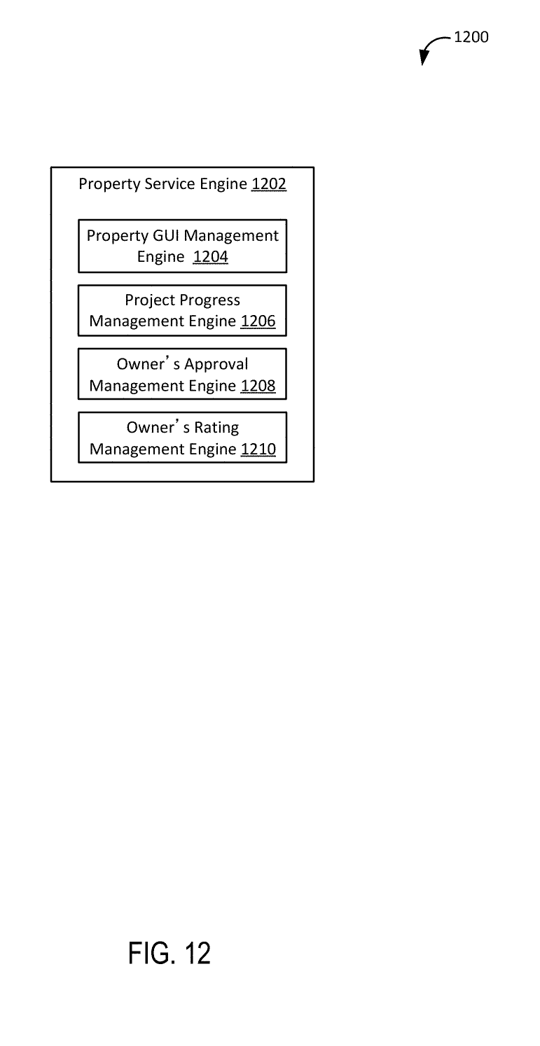

FIG. 12 is an architecture diagram 1200 illustrating a detailed structure of a property service engine according to some embodiments. In the example of FIG. 12, a property service engine 1202 includes a property GUI management engine 1204, a project progress management engine 1206, an owner's approval management engine 1208, and an owner's rating management engine 1210. In some embodiments, the property service engine 1202 corresponds to property service engine 224 in FIG. 2.

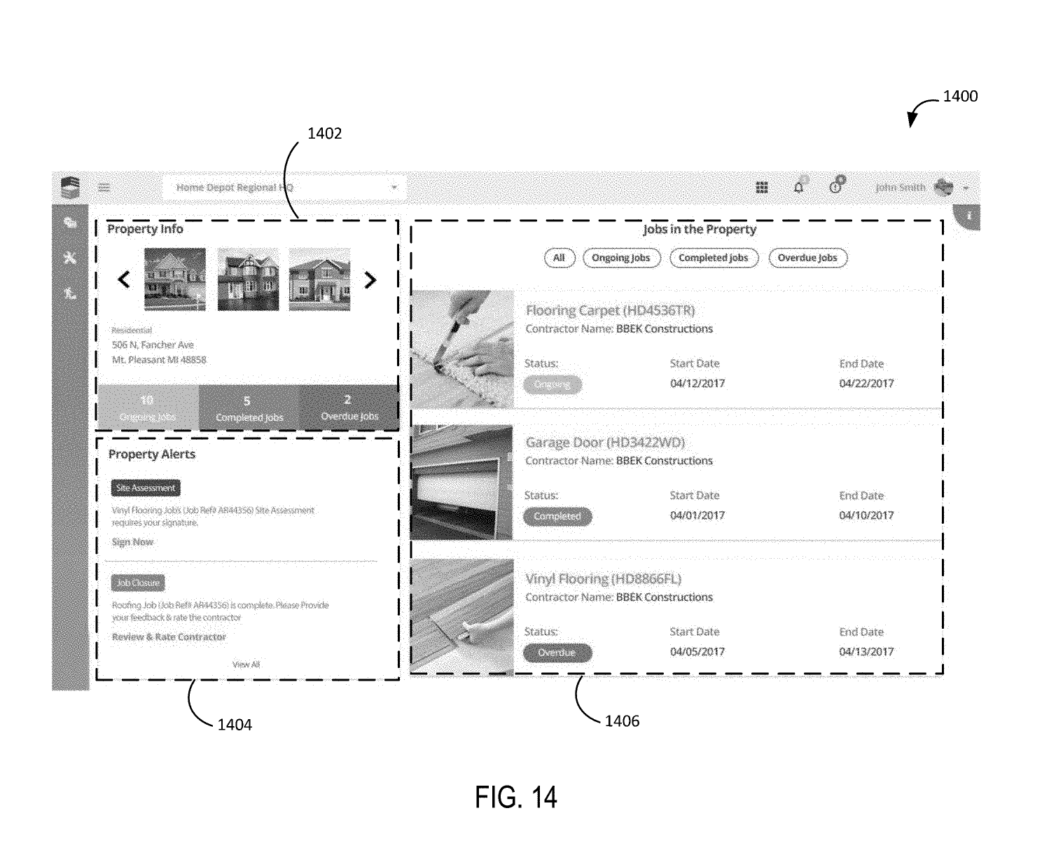

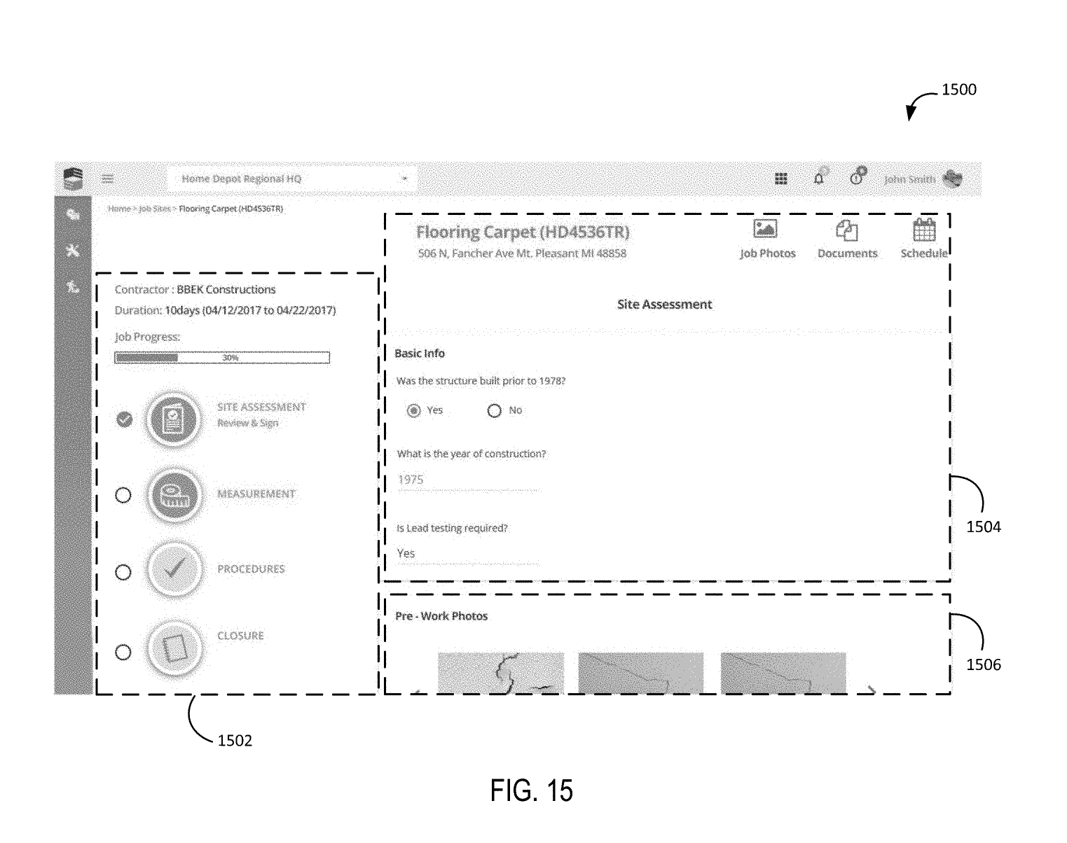

In the example of FIG. 12, the property GUI management engine 1204 may represent a functional module configured to manage contents to be included in property GUIs. A specific example of a GUI caused to be presented by the administrator GUI management engine 604 will be described with reference to FIGS. 14 and 15. In some embodiments, the property GUI management engine 1204 is configured to cause property GUIs to be presented to applicable terminals such as the property owner terminal 110 in FIG. 1. In some embodiments, a property GUI includes property details of a property, construction project details of a construction project performed on the property, alerts associated with the construction project, and so on. A property GUI may include a property survey GUI to be filled in by a property owner. For example, the property survey GUI includes inquiry about built year, occupants details (e.g., age), budgets, renovation history, etc. A property GUI may include a progress state of a construction project performed on a property owned by a property owner. A property GUI may, in some embodiments, include a signature input block in which an e-signature of a property owner is input to approve completion of construction project.

The project progress management engine 1206 may represent a functional module configured to manage project progress of construction projects. In some embodiments, the project progress management engine 1206 is configured to generate a construction property profile upon generation of a construction project profile for a construction project on a corresponding property. In some embodiment, the construction property profile includes property details of a property, construction project details of a construction project performed on the property, alerts associated with the construction project, and so on. In some embodiments, the project progress management engine 1206 is configured to update a construction property profile upon completion of the construction project on the corresponding property. For example, the project progress management engine 1206 updates a construction property profile as being completed upon update of construction project profiles of all construction projects on the property to completion.

The project progress management engine 1206 may be configured to generate a project report. In some embodiments, the project report includes details of a completed construction project, such as estimated start and end dates, actual start and end dates, worker details of worker involved in the project, detailed process steps that were performed, notes/comments made by workers, evidence inputs (e.g., photo images) for process steps including regulatory procedures, images of property portions before and after the project, and awareness of regulation-restricted materials (e.g., lead and asbestos), and so on. In some embodiments, the project progress management engine 1206 may cause the generated project report to be uploadable through a property GUI and/or to be delivered through electronic communication such as emails or mail delivery.

The owner's approval management engine 1208 may represent a functional module configured to manage a property owner's approval of a step of a construction project and/or the entire construction project. In some embodiments, the owner's approval management engine 1208 is configured to receive a property owner's approval (e.g., e-signature), which is input through a property GUI and/or a project GUI, and record the approval in association with a corresponding construction property profile and/or corresponding construction project profile(s).

The owner's rating management engine 1210 may represent a functional module configured to manage a property owner's rating of a construction project and/or one or more construction workers and one or more construction companies involved in the construction project. In some embodiments, the owner's rating management engine 1210 is configured to receive a property owner's rating inputs through a property GUI and/or a project GUI, and record the rating in association with a corresponding construction property profile, a corresponding construction worker profile, and/or corresponding construction project profile(s).

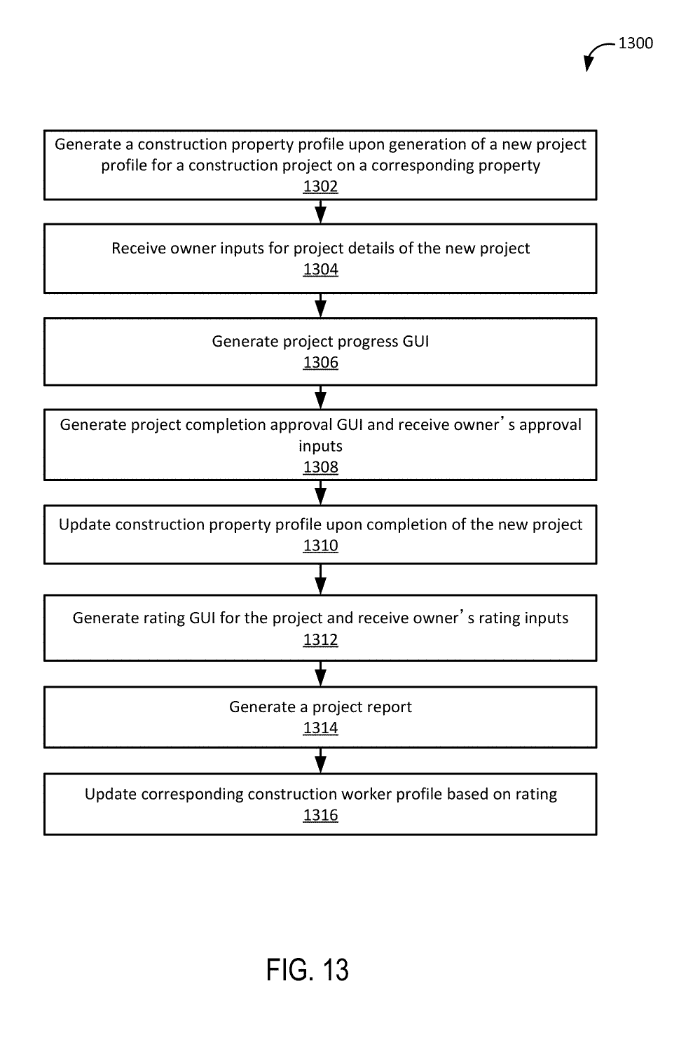

FIG. 13 is a flowchart 1300 of an example of a method for managing a construction property profile according to some embodiments. In module 1302 of FIG. 13, a construction property profile is generated upon generation of a construction project profile of a new construction project on a corresponding property. An applicable engine such as the project progress management engine 1206 in FIG. 12 generates the construction property profile. In some embodiments, the construction project profile and the construction property profile are uniquely associated with each other.

In module 1304 of FIG. 13, owner inputs for project details of the new project are received. An applicable engine such as the property GUI management engine 1204 in FIG. 12 and/or the GUI generation engine 214 in FIG. 2 may cause a GUI for receiving the owner inputs for project details of the new project to be presented to an applicable terminal such as the property owner terminal 110 in FIG. 1, and receives the owner inputs for project details. In some embodiments, the owner inputs are input through a property survey GUI include answer slots to be filled in by the property owner.

In module 1306 of FIG. 13, a project progress GUI is generated. An applicable engine such as the property GUI management engine 1204 in FIG. 12 and/or the GUI generation engine 214 in FIG. 2 may cause a property GUI for indicating the project progress to be presented to an applicable terminal such as the property owner terminal 110 in FIG. 1.

In module 1308 of FIG. 13, a project completion approval GUI is generated, and owner's approval inputs are received. An applicable engine such as the property GUI management engine 1204 in FIG. 12 and/or the GUI generation engine 214 in FIG. 2 may cause a GUI for receiving a project completion approval to be presented to an applicable terminal such as the property owner terminal 110 in FIG. 1, and receives the owner's approval inputs.

In module 1310 of FIG. 13, a construction property profile is updated upon completion of the new project. An applicable engine such as the project progress management engine 1206 in FIG. 12 updates the construction property profile, and may cause a property GUI for indicating a project progress to be updated on an applicable terminal such as the property owner terminal 110 in FIG. 1.

In module 1312 of FIG. 13, a rating GUI for the project is generated, and owner's rating inputs are received. An applicable engine such as the property GUI management engine 1204 in FIG. 12 and/or the GUI generation engine 214 in FIG. 2 may cause a GUI for receiving a rating of a construction project to be presented to an applicable terminal such as the property owner terminal 110 in FIG. 1, and receives the owner's rating inputs.

In module 1314 of FIG. 13, a project report is generated. An applicable engine such as the project progress management engine 1206 in FIG. 12 generates the project report and delivers the generated project report to an applicable terminal such as the property owner terminal 110 in FIG. 1.

In module 1316 of FIG. 13, corresponding construction worker profiles are updated based on rating. An applicable engine such as the project progress management engine 1206 in FIG. 12 may cause an applicable engine such as the stats/rating management engine 610 in FIG. 6 to update the corresponding construction worker profile. In some embodiments, rating also may cause update of an administrator GUI indicating rating of workers and/or construction entity.

FIG. 14 is a diagram 1400 illustrating an example of a GUI for providing property management service to property owners according to some embodiments. The GUI illustrated in FIG. 14 includes a property summary window 1402, a property alert window 1404, and a project list window 1406. In some embodiments, the GUI in FIG. 14 corresponds to a property portal GUI of a property.

In the example of FIG. 14, the property summary window 1402 includes property images and address of a property where a construction project undergoes, and visual presentation indicating the numbers of on-going projects, completed projects, and overdue projects by different colors.

The property alert window 1404 includes an alert requesting a signature by a property owner for a project to proceed to the next step in its workflow, and an alert requesting a signature by a property owner for a project to complete.

The project list window 1406 includes a list of projects performed on a property. For example, the list can be sorted and/or filtered by the progress state and the type of the projects. In one example, the list can show selectively one or more of on-going projects, completed projects, and overdue projects.

FIG. 15 is a diagram 1500 illustrating another example of a GUI for providing property management service to property owners according to some embodiments. The GUI illustrated in FIG. 15 includes a project progress window 1502, a project assessment window 1504, and a project before-and-after image window 1506. In some embodiments, the GUI in FIG. 15 corresponds to a property GUI of a property that can be navigated from a property portal GUI in FIG. 14, by selecting one of the projects on the property.

The window 1502 includes visual presentation of a progress state (e.g., by percentage) and visual presentation of one or more completed steps, one or more on-going steps, and one or more non-completed steps by different colors.

The window 1504 includes site assessment inquiry that can be input by a property owner. The site assessment inquiry includes inquiries related to determine necessity of regulatory procedures.

The window 1506 includes pre-work photos and post-work photos to show project results. Selection of a photo may lead to additional information associated with the selected photo, such as notes/comments made on the photo by workers.

Advantageously, according to one or more of the above described embodiments, it is possible to provide platforms for construction workers to manage a construction worker status, such that the construction worker properly maintain certificate/license status or comply with certificate/license requirements to perform assigned projects by taking necessary training courses. According to one or more of the above described embodiments, it is possible to provide platforms for construction workers to manage a construction work assignments, such that the construction worker properly perform construction work assignments in a scheduled manner. According to one or more of the above described embodiments, it is possible to provide platforms for administrators to manage construction projects, such that construction projects are performed in a scheduled manner by workers of its construction entity. According to one or more of the above described embodiments, it is possible to provide platforms for administrators to assign construction projects requiring regulatory procedure to workers who are authorized to perform the regulatory procedure, and provide platform for workers to perform the regulatory procedure in a proper order. According to one or more of the above described embodiments, it is possible to provide platforms for property owners to track progress and details of construction projects performed on the owner's property.

Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software, such as iOS, Android, Chrome OS, Windows XP, Windows Vista, Windows 7, Windows 8, Windows Server, Windows CE, Unix, Linux, SunOS, Solaris, iOS, Blackberry OS, VxWorks, or other compatible operating systems. In other embodiments, the computing device may be controlled by a proprietary operating system. Conventional operating systems control and schedule computer processes for execution, perform memory management, provide file system, networking, I/O services, and provide a user interface functionality, such as a graphical user interface (“GUI”), among other things.

FIG. 16 is a block diagram that illustrates a computer system 1600 upon which any of the embodiments described herein may be implemented. The computer system 1600 includes a bus 1602 or other communication mechanism for communicating information, one or more hardware processors 1604 coupled with bus 1602 for processing information. Hardware processor(s) 1604 may be, for example, one or more general purpose microprocessors.

The computer system 1600 also includes a main memory 1606, such as a random access memory (RAM), cache and/or other dynamic storage devices, coupled to bus 1602 for storing information and instructions to be executed by processor 1604. Main memory 1606 also may be used for storing temporary variables or other intermediate information during execution of instructions to be executed by processor 1604. Such instructions, when stored in storage media accessible to processor 1604, render computer system 1600 into a special-purpose machine that is customized to perform the operations specified in the instructions.

The computer system 1600 further includes a read only memory (ROM) 1608 or other static storage device coupled to bus 1602 for storing static information and instructions for processor 1604. A storage device 1610, such as a magnetic disk, optical disk, or USB thumb drive (Flash drive), etc., is provided and coupled to bus 1602 for storing information and instructions.

The computer system 1600 may be coupled via bus 1602 to a display 1612, such as a cathode ray tube (CRT) or LCD display (or touch screen), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 1600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 1600 may implement the techniques described herein using customized hard-wired logic, one or more ASICs or FPGAs, firmware and/or program logic which in combination with the computer system may cause or programs computer system 1600 to be a special-purpose machine. According to one embodiment, the techniques herein are performed by computer system 1600 in response to processor(s) 1604 executing one or more sequences of one or more instructions contained in main memory 1606. Such instructions may be read into main memory 1606 from another storage medium, such as storage device 1610. Execution of the sequences of instructions contained in main memory 1606 may cause processor(s) 1604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1610. Volatile media includes dynamic memory, such as main memory 1606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1602. Transmission media can also take the form of acoustic or light waves, such as those generated during radio-wave and infra-red data communications.

Various forms of media may be involved in carrying one or more sequences of one or more instructions to processor 1604 for execution. For example, the instructions may initially be carried on a magnetic disk or solid state drive of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may retrieves and executes the instructions. The instructions received by main memory 1606 may optionally be stored on storage device 1610 either before or after execution by processor 1604.

The computer system 1600 also includes a communication interface 1618 coupled to bus 1602. Communication interface 1618 provides a two-way data communication coupling to one or more network links that are connected to one or more local networks. For example, communication interface 1618 may be an integrated services digital network (ISDN) card, cable modem, satellite modem, or a modem to provide a data communication connection to a corresponding type of telephone line. As another example, communication interface 1618 may be a local area network (LAN) card to provide a data communication connection to a compatible LAN (or WAN component to communicated with a WAN). Wireless links may also be implemented. In any such implementation, communication interface 1618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 1618, which carry the digital data to and from computer system 1600, are example forms of transmission media.

The computer system 1600 can send messages and receive data, including program code, through the network(s), network link and communication interface 1618. In the Internet example, a server might transmit a requested code for an application program through the Internet, the ISP, the local network and the communication interface 1618.

The received code may be executed by processor 1604 as it is received, and/or stored in storage device 1610, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention(s) can be practiced in many ways. As is also stated above, it should be noted that the use of particular terminology when describing certain features or aspects of the invention(s) should not be taken to imply that the terminology is being re-defined herein to be restricted to including any specific characteristics of the features or aspects of the invention(s) with which that terminology is associated. The scope of the invention(s) should therefore be construed in accordance with the appended claims and any equivalents thereof.

Engines, Components, and Logic

Certain embodiments are described herein as including logic or a number of components, engines, or mechanisms. Engines may constitute either software engines (e.g., code embodied on a machine-readable medium) or hardware engines. A “hardware engine” is a tangible unit capable of performing certain operations and may be configured or arranged in a certain physical manner. In various example embodiments, one or more computer systems (e.g., a standalone computer system, a client computer system, or a server computer system) or one or more hardware engines of a computer system (e.g., a processor or a group of processors) may be configured by software (e.g., an application or application portion) as a hardware engine that operates to perform certain operations as described herein.

In some embodiments, a hardware engine may be implemented mechanically, electronically, or any suitable combination thereof. For example, a hardware engine may include dedicated circuitry or logic that is permanently configured to perform certain operations. For example, a hardware engine may be a special-purpose processor, such as a Field-Programmable Gate Array (FPGA) or an Application Specific Integrated Circuit (ASIC). A hardware engine may also include programmable logic or circuitry that is temporarily configured by software to perform certain operations. For example, a hardware engine may include software executed by a general-purpose processor or other programmable processor. Once configured by such software, hardware engines become specific machines (or specific components of a machine) uniquely tailored to perform the configured functions and are no longer general-purpose processors. It will be appreciated that the decision to implement a hardware engine mechanically, in dedicated and permanently configured circuitry, or in temporarily configured circuitry (e.g., configured by software) may be driven by cost and time considerations.

Accordingly, the phrase “hardware engine” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented engine” refers to a hardware engine. Considering embodiments in which hardware engines are temporarily configured (e.g., programmed), each of the hardware engines need not be configured or instantiated at any one instance in time. For example, where a hardware engine comprises a general-purpose processor configured by software to become a special-purpose processor, the general-purpose processor may be configured as respectively different special-purpose processors (e.g., comprising different hardware engines) at different times. Software accordingly configures a particular processor or processors, for example, to constitute a particular hardware engine at one instance of time and to constitute a different hardware engine at a different instance of time.

Hardware engines can provide information to, and receive information from, other hardware engines. Accordingly, the described hardware engines may be regarded as being communicatively coupled. Where multiple hardware engines exist contemporaneously, communications may be achieved through signal transmission (e.g., over appropriate circuits and buses) between or among two or more of the hardware engines. In embodiments in which multiple hardware engines are configured or instantiated at different times, communications between such hardware engines may be achieved, for example, through the storage and retrieval of information in memory structures to which the multiple hardware engines have access. For example, one hardware engine may perform an operation and store the output of that operation in a memory device to which it is communicatively coupled. A further hardware engine may then, at a later time, access the memory device to retrieve and process the stored output. Hardware engines may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein. As used herein, “processor-implemented engine” refers to a hardware engine implemented using one or more processors.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that an “engine,” “system,” “data store,” and/or “database” may comprise software, hardware, firmware, and/or circuitry. In one example, one or more software programs comprising instructions capable of being executable by a processor may perform one or more of the functions of the engines, data stores, databases, or systems described herein. In another example, circuitry may perform the same or similar functions. Alternative embodiments may comprise more, less, or functionally equivalent engines, systems, data stores, or databases, and still be within the scope of present embodiments. For example, the functionality of the various systems, engines, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, engines, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Although the invention(s) has been described in detail for the purpose of illustration based on what is currently considered to be the most practical and preferred implementations, it is to be understood that such detail is solely for that purpose and that the invention(s) are not limited to the disclosed implementations, but, on the contrary, is intended to cover modifications and equivalent arrangements that are within the spirit and scope of the appended claims. For example, it is to be understood that the present invention(s) contemplates that, to the extent possible, one or more features of any embodiment can be combined with one or more features of any other embodiment.

1. A system for construction project management graphical user interfaces (GUIs) comprising:
one or more processors; and
a memory storing instructions for a construction project that, when executed by the one or more processors, cause the system to:
generate a project profile for a construction project at a property;
determine project details of the construction project;
determine a regulatory process to be performed with respect to the property during the construction project based on the project details and regulatory rules;
determine worker's certificates or licenses corresponding to the regulatory process and the project details of the construction project;
determine candidate workers for the construction project from registered workers for whom worker profiles are registered, worker profiles for the candidate workers including the worker's certificates or licenses corresponding to the regulatory process; and
cause a first GUI for selection of one or more candidate workers to be generated, the first GUI including indicators of statuses of the worker's certificates or licenses corresponding to the regulatory process with respect to each of the one or more candidate workers.

2. The system of claim 1, wherein the instructions further cause the system to:
determine a workflow of the construction project based on the project details and the regulatory process to be performed; and
cause a second GUI indicating the determined workflow of the construction project to be generated on terminals associated with one or more of the candidate workers selected through the GUI.

3. The system of claim 2, wherein the instructions further cause the system to validate a completion of a step of the workflow based on an on-site input for the step.

4. The system of claim 3, wherein the instructions further cause the system to disable the validation of the completion of the step of the workflow when the on-site input is associated with a worker whose worker profile indicates lack of a certificate or a license required to perform the step.

5. The system of claim 3, wherein the instructions further cause the system to disable validation a completion of a second step of the workflow that follows the step of the workflow until the validation of the completion of the step.

6. The system of claim 2, wherein the instructions further cause the system to enable approval of completion of the construction project based on a signature input, upon validation of a last step of the workflow.

7. The system of claim 2, wherein the instructions further cause the system to, upon completion of steps of the workflow, close the project profile and update worker profiles of the one or more selected candidate workers such that the worker profiles include project history of the construction project.

8. The system of claim 2, wherein the instructions further cause the system to, upon completion of steps of the workflow, cause a third GUI for rating the construction project to be generated.

9. The system of claim 1, wherein the instructions further cause the system to:
determine certifications or licenses associated with one or more construction project assignments;
determine whether or not a worker has the determined certifications or licenses by referring to a worker profile of the worker; and
upon determining that the worker possesses at least one of the determined certifications or licenses, determine an expiration date of the at least one certification or license, and causing a fourth GUI including a notification of the expiration date of the at least one certification or license to be generated on a terminal associated with the worker.

10. The system of claim 1, wherein the instructions further cause the system to:
determine certifications or licenses for one or more construction project assignments;
determine whether or not a worker has the determined certifications or licenses by referring to a worker profile of the worker; and
upon determining that the worker possesses none of the determined certifications or licenses, cause a fifth GUI including a notification of missing certifications or licenses to be generated on a terminal associated with the worker.

11. The system of claim 1, wherein the instructions further cause the system to:
cause a fifth GUI for starting an online training session associated with one of the determined certifications or licenses to be generated on a terminal associated with a worker; and
cause a sixth GUI of the online training session to be generated upon start of the online training session.

12. The system of claim 11, wherein the instructions further cause the system to update a status of the one of the determined certifications or licenses included in the worker profile as being possessed, upon completion of the online training session.

13. A method for construction project management graphical user interfaces (GUIs) comprising:
generating a project profile for a construction project at a property;
determining project details of the construction project;
determining a regulatory process to be performed with respect to the property during the construction project based on the project details and regulatory rules;
determining worker's certificates or licenses corresponding to the regulatory process and the project details of the construction project;
determining candidate workers for the construction project from registered workers for whom worker profiles are registered, worker profiles for the candidate workers including the worker's certificates or licenses corresponding to the regulatory process; and
causing a first GUI for selection of one or more candidate workers to be generated, the first GUI including indicators of statuses of the worker's certificates or licenses corresponding to the regulatory process with respect to each of the one or more candidate workers.

14. The method of claim 13, further comprising:
determining a workflow of the construction project based on the project details and the regulatory process to be performed; and
causing a second GUI indicating the determined workflow of the construction project to be generated on terminals associated with one or more of the candidate workers selected through the GUI.

15. The method of claim 14, further comprising validating a completion of a step of the workflow based on an on-site input for the step.

16. The method of claim 15, further comprising disabling the validation of the completion of the step of the workflow when the on-site input is associated with a worker whose worker profile indicates lack of a certificate or a license required to perform the step.

17. The method of claim 15, further comprising disabling validation a completion of a second step of the workflow that follows the step of the workflow until the validation of the completion of the step.

18. The method of claim 14, further comprising enabling approval of completion of the construction project based on a signature input, upon validation of a last step of the workflow.

19. The method of claim 14, further comprising, upon completion of steps of the workflow, closing the project profile and updating worker profiles of the one or more selected candidate workers such that the worker profiles include project history of the construction project.

20. The method of claim 14, further comprising, upon completion of steps of the workflow, cause a third GUI for rating the construction project to be generated.

21. The method of claim 13, further comprising:
determining certifications or licenses associated with one or more construction project assignments;
determining whether or not a worker has the determined certifications or licenses by referring to a worker profile of the worker; and
upon determining that the worker possesses at least one of the determined certifications or licenses, determining an expiration date of the at least one certification or license, and causing a fourth GUI including a notification of the expiration date of the at least one certification or license to be generated on a terminal associated with the worker.

22. The method of claim 13, further comprising:
determining certifications or licenses for one or more construction project assignments;
determining whether or not a worker has the determined certifications or licenses by referring to a worker profile of the worker; and
upon determining that the worker possesses none of the determined certifications or licenses, causing a fifth GUI including a notification of missing certifications or licenses to be generated on a terminal associated with the worker.

23. The method of claim 13, further comprising:
causing a fifth GUI for starting an online training session associated with one of the determined certifications or licenses to be generated on a terminal associated with a worker; and
causing a sixth GUI of the online training session to be generated upon start of the online training session.

24. The method of claim 23, further comprising updating a status of the one of the determined certifications or licenses included in the worker profile as being possessed, upon completion of the online training session.
